(19) United States
(12) Patent Application Publication
(10) Pub. No.: US 2023/0225324 A1
(43) Pub. Date: Jul. 20, 2023

(54) Synergistic Pesticidal Composition Against Sucking Pests Complex

(71) Applicant: Best Agrolife Limited, New Dehli, Dehi (IN)

(72) Inventors: Vimal Kumar, New Dehli, Dehli (IN); Raajan Kumar Ailawadhi, New Dehli, Dehli (IN); Ajit S. Gujral, New Dehli, Dehli (IN)

(21) Appl. No.: 18/008,424

(22) PCT Filed: Jun. 12, 2021
(86) PCT No.: PCT/IB2021/055191

§ 371 Date: Dec. 5, 2022

(30) Foreign Application Priority Data
Jun. 5, 2020 (IN) 202011023685

(51) Int. Cl. A01N 47/30; A01N 43/40; A01N 43/88; A01N 43/08; A01P 7/00; A01N 25/30

(52) U.S. Cl. CPC A01N 47/30; A01N 43/40; A01N 43/88; A01N 43/08; A01P 7/00; A01N 25/30

(57) ABSTRACT

A Synergistic pesticidal composition against sucking pests complex. More particularly the present invention relates to a synergistic pesticidal composition comprising of bioactive amount of Diafenthiuron and Pyriproxyfen with at least one agro-chemically active insecticide selected from Thiamethoxam, Imidacloprid, Thiacloprid, Dinotefuran, Clothianidin, and Pymetrozine. The present invention further relates to process for preparing the said compositions in specific ratio. The present invention further relates to the process for preparing the said composition along with at least one inactive excipient; and formulations thereof. The present invention further relates to the synergistic insecticidal compositions, wherein active ingredient present infixed ratio shows synergy in insecticidal activity and formulation thereof are stable in nature.

### FIELD OF THE INVENTION

The present invention relates to synergistic pesticidal compositions against sucking pests complex. More particularly, the present invention relates to a synergistic pesticidal composition comprising of bioactive amounts of Diafenthiuron; Pyriproxyfen; and at least one agro-chemically active insecticide selected from Thiamethoxam, Imidacloprid, Thiacloprid, Dinotefuran, Clothianidin, and Pymetrozine. The present invention also relates to process for preparing such compositions.

### BACKGROUND OF THE INVENTION

Pesticides including insecticides are used widely and very frequently in commercial agriculture and have enabled an enormous increase in crop yields and product quality which ultimately increased the ease to farmers in term of economic advantage as well as ease of farming activities.

Insecticides are a type of pesticide that is used to specifically target and kill insects. Some insecticides include snail bait, ant killer, and wasp killer. An insecticide is a substance used to kill insects. They include ovicides and larvicides used against insect eggs and larvae, respectively. Insecticides are used in agriculture, medicine, industry and by consumers.

In general use, the pesticide actives are used in the form of a dilute aqueous composition because it can attain a good interaction with the target organism, such as plants, fungi and insects. However, most active pesticide compounds that are used as pesticides are only sparingly or even insoluble in water. The low solubility of such compounds present the challenges and difficulties to formulator in formulating pesticide compounds in stable formulations that can be easily stored for a long time and which still have a high stability and effective activity until end use. This problem especially occurs and may get worsen if more than one active compound is present in the composition.

Various compositions have been developed to control insect-pests and in practice have been used as a single or mixed agent. Practical agricultural experience has shown that the repeated and exclusive application of an individual active compound for the control of harmful insect-pests leads in many cases to a rapid selection of those strains which have developed natural or adapted resistance against the active compound in question. Effective control of such insect-pests with the active compound in question is very difficult in such cases.

To reduce the risk of the selection strains, mixtures of different active compounds are employed for controlling insect-pests. It is possible to ensure successful control over a relatively long period of time by combining active compounds having different mechanisms of action.

Certain mixtures of active compounds are proposed for pest control in the earlier literature. U.S. Pat. No. 4,104,376 discloses a synergistic formulation for insect control comprised of a combination of phosphorodithioate and formamidine at a ratio of 1 to 0.1-1.0, preferably 1 to about 0.2-0.5.

U.S. Pat. No. 4,613,617 discloses synergistic compositions for insect control comprising dione esters and other insecticides, such as pyrethroids, carba-mates and organophosphates. U.S. Pat. No. 4,767,773 discloses synergistic compositions for insect control comprising benzoyl ureas and pyrethroids, carbamates, and organophosphates.

U.S. Pat. No. 5,187,184 discloses that synergistic compositions for insect control comprising adding aryl nitro pyrrole or arylpyrrole-carbonitrile to a compositions of aryl pyrazole carboximide provides superior pest control at lower levels of the combined active ingredients than may be achieved with the aryl nitro pyrrole or aryl pyrrole carbo nitrile or aryl pyrazole carboximide applied alone at equal or higher levels than the total amount of active agent used in the combination treatment.

U.S. Pat. No. 5,491,168 discloses synergistic compositions for insect control comprising propargite (tert. butyl phenoxy cyclohexyl propynyl sulfite) and a pyrethroid. Finally, JP Kokai (A) H8-198719 published Aug. 6, 1996 discloses agricultural and horticultural fungicides comprised of a synergistic combination of a substance which inhibits the complex I enzyme reaction of the mitochondria electron transfer system (e.g., Pyridaben) and a substance which inhibits the complex III enzyme reaction of the mitochondria electron transfer system (e.g., kresoxim-methyl). (Entire content of all these prior arts are expressly incorporated hereinto by reference).

753/MUM/2012 relates to a composition comprising an effective amount of lambda Cyhalothrin in the range of 0.5% to 12%; an effective amount of Diafenthiuron in the range of 15% to 70% wherein the ratio of Lambda Cyhalothr into Diafenthiuron is in the range of 1:4 to 1:35; and at least one agrochemical excipient.

However, the biological properties of these mixtures of known compounds mentioned above are not completely satisfactory in the field of pest control.

Thus, there still exists a need to develop novel pesticidal compositions showing a broader scope of activity and a synergistic effect in order to avoid or to control the development of resistant strains to the active ingredients/compounds or to the mixtures of known active ingredients used by farmer while minimizing the doses of chemical products spread in the environment and reducing the cost of the treatment. A need also exists for synergistic pesticidal compositions which shall be physio-chemically compatible formulations in the form of storage stable, safely packed and ready to use formulation.

In particular, there exists a need for a synergistic composition of Diafenthiuron; Pyriproxyfen in combination with Neonicotinoid insecticides.

Diafenthiuron was first disclosed in GB2060626. Diafenthiuron is chemically known as 1-tert-butyl-3-(2,6-di-isopropyl-4-phenoxyphenyl)thiourea or N-[2,6-bis(1-methylethyl)-4-phenoxyphenyl]-N′-(1,1dimethyl-ethyl)thiourea and having chemical structure as below:

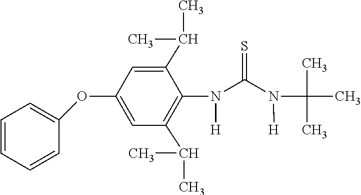 [SMILES: CC(C)c1cc(Oc2ccccc2)cc(C(C)C)c1NC(=S)NC(C)(C)C]

Diafenthiuron is a broad spectrum insecticide having contact and stomach action. Diafenthiuron acts after conversion by either light, or in vivo, to the corresponding carbodiimide, which is an inhibitor of mitochondrial respiration. Mode of action as insecticide and acaricide which kills larvae, nymphs and adults is by contact and/or stomach action; also shows some ovicidal action. It is commonly used as insecticide and acaricide effective against phytophagous mites (tetranychidae, tarsonemidae), aleyrodidae, aphididae and jassidae on cotton, various field and fruit crops, ornamentals and vegetables. The effect of Diafenthiuron is based on the inhibition of ATP synthesis. Diafenthiuron also controls some leaf-feeding pests in cole crops (Plutellaxylostella), soya beans (Anticarsiagemmatalis) and cotton (Alabama argillacea).

Pyriproxyfen, is chemically known as 4-phenoxyphenyl (RS)-2-(2-pyridyloxy)propyl ether 2-[1-(4-phenoxyphenoxy)propan-2-yloxy]pyridine and having chemical structure as below:

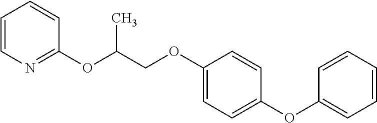 [SMILES: CC(COc1ccc(Oc2ccccc2)cc1)Oc1ccccn1]

Pyriproxyfen is a pyridine-based pesticide which is found to be effective against a variety of arthropoda. Pyriproxyfen is a solid (melting range 48-50° C.) of low volatility and only slightly soluble in water. It was introduced to the US in 1996, to protect cotton crops against whitefly. It has also been found useful for protecting other crops. It is also used as prevention for fleas on household pets. Pyriproxyfen is a juvenile hormone analog and an insect growth regulator, preventing larvae from developing into adulthood and thus rendering them unable to reproduce.

Neonicotinoids being broad spectrum insecticides are a class of neuro-active insecticides chemically similar to nicotine. Neonicotinoids are neurotoxins that target the nicotinic acetylcholine receptor acting as agonists. Neonicotinoids also affects the CNS (central nervous system) of the insects as it binds agonistically to the post-synaptic nicotinic acetylcholine receptors that results in the spontaneous discharge of nerve impulses and eventual failure of the neuron to propagate any signal. Although they are effective as contact insecticides, it is the ability of these chemicals to translocate from the soil into leaves as systemic insecticides that has been one of the primary reasons for their popularity. Neonicotinoids are used to protect a variety of vegetables, fruits, and major crops like corn, cotton, potato, rice, etc. against sucking insects like aphids, whiteflies, thrips, leaf- and plant hoppers. These insecticides are recommended for the control of sucking pests of cotton, as they are most effective against thrips, jassid, and whitefly.

Amongst the chemical classification of Neonicotinoids, three categories have been identified, which are listed as under:
A. Chloropyridylmethyl/First-generation neonicotinoids
   i. Imidacloprid
   ii. Thiacloprid
   iii. Acetamiprid
   iv. Nitenpyram
B. ChloroThiozolylmethyl/Second-generation neonicotinoids
   i. Thiamethoxam
   ii. Clothianidin
C. Tetrahydrofuranylmethyl/Third-generation neonicotinoids
   i. Dinotefuran
   ii. Cycloxaprid

Under the natural law of selection, in order to control one particular species of pest attacking the crop at a particular stage of the crop, combination of pesticides have been applied. Thus, by such application of combination of pesticides, natural balance is maintained and nature pushes another species of pests to flourish and attack the crops thereby rendering the crops still vulnerable to the pest attack and hence farmer loses substantial part of its produce. To address this, it has been found by the inventors of the present application that to the composition of Diafenthiuron; Pyriproxyfen, a third category of insecticides (selective neonicotinoids) have been combined which provide a broad spectrum control over all the sucking pests attacking the crops (including cotton) under the theory of natural selection mentioned herein.

Thus, there exists a need for a synergistic composition of Diafenthiuron; Pyriproxyfen in combination with at least one agro-chemically active insecticide. In particular, there exists a need for a synergistic composition of Diafenthiuron; Pyriproxyfen in combination with at least one agro-chemically active insecticide selected from Thiamethoxam, Imidacloprid, Thiacloprid, Dinotefuran, Clothianidin, and Pymetrozine, which overcomes some of the existing problems mentioned above and can be prepared easily without much complex manufacturing process.

Inventors of the present invention have surprisingly found that the novel synergistic composition of Diafenthiuron; Pyriproxyfen; and an insecticide selected from Thiamethoxam, Imidacloprid, Thiacloprid, Dinotefuran, Clothianidin, and Pymetrozine provide solution to the above mentioned problems. Thus, the object is achieved according to the invention by providing the present composition.

### SUMMARY OF THE INVENTION

Accordingly, in a first aspect, the present invention provides a synergistic pesticidal composition comprising (A) Diafenthiuron (B) Pyriproxyfen (C) at least one insecticide selected from Thiamethoxam, Imidacloprid, Thiacloprid, Dinotefuran, Clothianidin, and Pymetrozine and one or more inactive excipients.

Accordingly, in a further aspect, the present invention provides a synergistic pesticidal composition comprising A) Diafenthiuron is present in an amount in the range from 5.0 to 60% w/w; B) Pyriproxyfen is present in an amount in the range from 1.0 to 25% w/w; C) at least one more insecticide selected from Thiamethoxam, Imidacloprid, Thiacloprid, Dinotefuran, Clothianidin, Pymetrozine, is present in an amount in the range from 0.5 to 50% w/w.

Accordingly, in a further aspect, the present invention provides a synergistic pesticidal composition comprising:
a) Diafenthiuron in an amount in the range from 15-35% w/w, Pyriproxyfen in an amount in the range from 5-25% w/w, Thiamethoxam in an amount in the range from 2.5-15% w/w and one or more inactive excipients, or
b) Diafenthiuron in an amount in the range from 5-14% w/w, Pyriproxyfen in an amount in the range from 2.8-4% w/w, Thiamethoxam in an amount in the range from 15.1-35% w/w and one or more inactive excipients, or
c) Diafenthiuron in an amount in the range from 40-60% w/w, Pyriproxyfen in an amount in the range from 1-2.7% w/w, Thiamethoxam in an amount in the range from 35.1-50% w/w and one or more inactive excipients, or
d) Diafenthiuron in an amount in the range from 15-35% w/w, Pyriproxyfen in an amount in the range from 5-25% w/w, Imidacloprid in an amount in the range from 5-15% w/w and one or more inactive excipients, or
e) Diafenthiuron in an amount in the range from 5-14% w/w, Pyriproxyfen in an amount in the range from 2.8-4.9% w/w, Imidacloprid in an amount in the range from 15.1-35% w/w and one or more inactive excipients, or
f) Diafenthiuron in an amount in the range from 40-60% w/w, Pyriproxyfen in an amount in the range from 1-2.7% w/w, Imidacloprid in an amount in the range from 35.1-50% w/w and one or more inactive excipients, or
g) Diafenthiuron in an amount in the range from 15-35% w/w, Pyriproxyfen in an amount in the range from 5-25% w/w, Thiacloprid in an amount in the range from 2.5-10% w/w and one or more inactive excipients, or
h) Diafenthiuron in an amount in the range from 5-14% w/w, Pyriproxyfen in an amount in the range from 2.8-4.9% w/w, Thiacloprid in an amount in the range from 10-20% w/w and one or more inactive excipients, or
i) Diafenthiuron in an amount in the range from 40-60% w/w, Pyriproxyfen in an amount in the range from 1-2.7% w/w, Thiacloprid in an amount in the range from 20.1-50% w/w and one or more inactive excipients, or
j) Diafenthiuron in an amount in the range from 15.0-35.0% w/w, Pyriproxyfen in an amount in the range from 5.0-25% w/w, Dinotefuran in an amount in the range from 0.5-15% w/w and one or more inactive excipients, or
k) Diafenthiuron in an amount in the range from 5.0-14% w/w, Pyriproxyfen in an amount in the range from 2.8-4.9% w/w, Dinotefuran in an amount in the range from 15.1-35% w/w and one or more inactive excipients, or
l) Diafenthiuron in an amount in the range from 40-60% w/w, Pyriproxyfen in an amount in the range from 1.0-2.7% w/w, Dinotefuran in an amount in the range from 35.1-50% w/w and one or more inactive excipients, or
m) Diafenthiuron in an amount in the range from 15-35% w/w, Pyriproxyfen in an amount in the range from 5-25% w/w, Clothianidin in an amount in the range from 2.5-15% w/w and one or more inactive excipients, or
n) Diafenthiuron in an amount in the range from 5-14% w/w, Pyriproxyfen in an amount in the range from 2.8-4.9% w/w, Clothianidin in an amount in the range from 15.1-25% w/w and one or more inactive excipients, or
o) Diafenthiuron in an amount in the range from 40-60% w/w, Pyriproxyfen in an amount in the range from 1-2.7% w/w, Clothianidin in an amount in the range from 25.1-40% w/w and one or more inactive excipients, or
p) Diafenthiuron in an amount in the range from 15-35% w/w, Pyriproxyfen in an amount in the range from 5-25% w/w, Pymetrozine in an amount in the range from 0.5-15% w/w and one or more inactive excipients, or
q) Diafenthiuron in an amount in the range from 5-14% w/w, Pyriproxyfen in an amount in the range from 2.8-4.9% w/w, Pymetrozine in an amount in the range from 15.1-35% w/w and one or more inactive excipients, or
r) Diafenthiuron in an amount in the range from 40-60% w/w, Pyriproxyfen in an amount in the range from 1-2.7% w/w, Pymetrozine in an amount in the range from 35.1-50% w/w and one or more inactive excipients

Accordingly, in a second aspect, the present invention provides a method of preparing the synergistic pesticidal composition of Diafenthiuron, Pyriproxyfen along with at least one insecticide selected from Thiamethoxam, Imidacloprid, Thiacloprid, Dinotefuran, Clothianidin, and Pymetrozine and one or more inactive excipients.

Accordingly, in a further aspect, the present invention provides a method of protecting a plant propagation material, a plant, parts of a plant and/or plant organs that grow at a later point in time against pathogenic damage or pest damage (including sucking pests complex) by applying to the plant propagation material a composition comprising a pesticidal composition defined in the first and further aspects.

Accordingly, in a yet another aspect, the said pesticidal composition is formulation selected from Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable Slurry (FS), Flowable Suspension (FS), Suspension Concentrate (SC), Suspension concentrate for direct application (SD), Suspo-emulsion (SE), Water soluble granule (SG), Soluble concentrate (SL), Water soluble powder (SP), Water dispersible powder for slurry seed treatment (WS), Water dispersible granules (WDG), Wettable powders (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW) comprising (A) Diafenthiuron (B) Pyriproxyfen (C) at least one insecticide selected from Thiamethoxam, Imidacloprid, Thiacloprid, Dinotefuran, Clothianidin, and Pymetrozine and one or more inactive excipients such as a) dispersant b) wetting agent c) anti-foaming agent d) biocides/anti-bacterial e) anti-freezing agent f) suspending agent g)thickener h) coating agent and i) buffering agent and binders.

As per one embodiment, formulation for the pesticidal composition is selected from Flowable Slurry (FS), Flowable Suspension (FS), Suspension Concentrate (SC), Suspo-emulsion (SE), Water dispersible powder for slurry seed treatment (WS), Water dispersible granules (WDG) and Wettable powders (WP).

The remainder of the aqueous formulation is preferably wholly water but may comprise other materials, such as inorganic salts. The formulation is preferably, completely free from organic solvents.

Accordingly, in another aspect, the present invention provides a pesticidal composition comprising (A) Diafenthiuron in an amount in the range from 5.0 to 60% w/w (B) Pyriproxyfen in an amount in the range from 1.0 to 25% w/w (C) at least one insecticide selected from Thiamethoxam, Imidacloprid, Thiacloprid, Dinotefuran, Clothianidin, Pymetrozine, in an amount in the range from 0.5 to 50% w/w shows synergistic activity; and formulation thereof is stable in nature.

### DETAILED DESCRIPTION OF THE INVENTION

Discussed below are some representative embodiments of the present invention. The invention in its broader aspects is not limited to the specific details and representative methods. The illustrative examples are described in this section in connection with the embodiments and methods provided. The invention according to its various aspects is particularly pointed out and distinctly claimed in the appended claims read in view of this specification and appropriate equivalents.

It is to be noted that, as used in the specification and the appended claims, the singular forms “a”, “an” and “the” include plural referents unless the context clearly dictates otherwise. Thus, for example, reference to a composition containing “a compound” includes a mixture of two or more compounds. It should also be noted that the term “or” is generally employed in its sense including “and/or” unless the content clearly dictates otherwise.

The expression of various quantities in terms of “% w/w” or “%” means the percentage by weight, relative to the weight of the total solution or composition unless otherwise specified.

The term “active ingredient” (a.i.) or “active agent” used herein refers to that component of the composition responsible for control of insects-pests or disease.

“Bioactive amounts” as mentioned herein means that amount which, when applied treatment of crops, is sufficient to effect such treatment. The bioactive amount of the compositions will also vary according to the prevailing conditions such as desired pesticidal effect and duration, weather, target species, locus, mode of application, and the like.

As used herein, the term “effective amount” means the amount of the active substances in the compositions to achieve an observable effect on growth, including the effects of necrosis, death, retardation, prevention, and removal, destruction, or otherwise diminishing the occurrence and activity of the target organism.

As used herein, the term “Diafenthiuron” encompasses Diafenthiuron or its agrochemically acceptable salt(s), derivative(s) or any other modified form of Diafenthiuron.

As used herein, the term “Pyriproxyfen” encompasses Pyriproxyfen or its agrochemically acceptable salt(s), derivative(s) or any other modified form of Pyriproxyfen.

The present invention provides a novel synergistic pesticidal composition comprising bioactive amounts of Diafenthiuron; Pyriproxyfen; and an at least one insecticide selected from Thiamethoxam, Imidacloprid, Thiacloprid, Dinotefuran, Clothianidin, Pymetrozine; along with one or more inactive excipients.

The present invention provides formulation for the aforesaid composition and method of preparation thereof.

The term “synergistic”, as used herein, refers the combined action of two or more active agents blended together and administered conjointly that is greater than the sum of their individual effects.

The present invention relates to synergistic insecticidal compositions of comprising of bioactive amounts of Diafenthiuron; Pyriproxyfen; and at least one active ingredients selected from Thiamethoxam, Imidacloprid, Thiacloprid, Dinotefuran, Clothianidin, Pymetrozine.

Pymetrozine was first disclosed in U.S. Pat. Nos. 4,931,439 and 4,996,325. Pymetrozinee is chemically known as (E)-4,5-dihydro-6-methyl-4-(3-pyridylmethyleneamino)-1,2,4-triazin-3(2H)-one and having chemical structure as below:

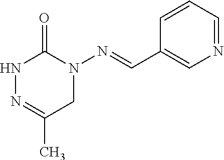 [SMILES: CC1=NNC(=O)N(/N=C/c2cccnc2)C1]

The mode of action of Pymetrozine in insects has not been precisely determined biochemically, but it may involve effects on neuroregulation or nerve-muscle interaction. Physiologically, it appears to act by preventing these insects from inserting their stylus in to the plant tissue.

As used herein, the term “Pymetrozine” encompasses Pymetrozine or its agrochemically acceptable salt(s), derivative(s) or any other modified form of Pymetrozine.

Imidacloprid is a neonicotinoid, which is a class of neuro-active insecticides modeled after nicotine. Imidacloprid is chemically known as a (NE)-N-[1-[(6-chloropyridin-3-yl)methyl]imidazolidin-2-ylidene]nitramide and having chemical structure as below:

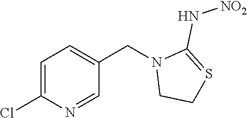

Imidacloprid is a systemic insecticide that acts as an insect neurotoxin and belongs to a class of chemicals called the neonicotinoids which act on the central nervous system of insects. The chemical works by interfering with the transmission of stimuli in the insect nervous system.

As used herein, the term “Imidacloprid” encompasses Imidacloprid or its agrochemically acceptable salt(s), derivative(s) or any other modified form of Imidacloprid.

Thiacloprid is a nitrile that is cyanamide in which the hydrogens are replaced by a 1,3-thiazolidin-2-ylidene group which in turn is substituted by a (6-chloropyridin-3-yl)methyl group at the ring nitrogen. It has a role as a xenobiotic, an environmental contaminant and a neonicotinoid insectide. It is a member of thiazolidines, a nitrile and a monochloropyridine. It is derived from 2-chloropyridine and a cyanamide. Thiacloprid is chemically known as a [3-[(6-chloropyridin-3-yl)methyl]-1,3-thiazolidin-2-ylidene]cyanamide and having chemical structure as below:

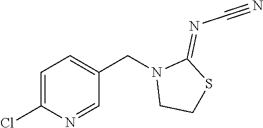 [SMILES: N#C/N=C1\SCCN1Cc1ccc(Cl)nc1]

Thiacloprid is an insecticide of the neonicotinoid class. Its mechanism of action is similar to other neonicotinoids and involves disruption of the insect's nervous system by stimulating nicotinic acetylcholine receptors.

As used herein, the term “Thiacloprid” encompasses Thiacloprid or its agrochemically acceptable salt(s), derivative(s) or any other modified form of Thiacloprid.

Dinotefuran is an insecticide of the neonicotinoid class for control of insect pests such as aphids, whiteflies, thrips, leafhoppers, leafminers, sawflies, mole cricket, white grubs, lacebugs, billbugs, beetles, mealybugs, and cockroaches on leafy vegetables, in residential and commercial buildings, and for professional turf management. Dinotefuran is chemically known as 2-methyl-1-nitro-3-[(tetrahydro-3-furanyl)methyl]guanidine and having chemical structure as below:

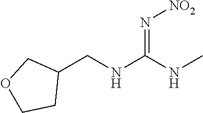

Its mechanism of action involves disruption of the insect's nervous system by inhibiting nicotinic acetylcholine receptors.

As used herein, the term “Dinotefuran” encompasses Dinotefuran or its agrochemically acceptable salt(s), derivative(s) or any other modified form of Dinotefuran.

Thiamethoxam is a neonicotinoid insecticide. It is an oxadiazane, a member of 1,3-thiazoles, an organochlorine compound and a 2-nitroguanidine derivative. Thiamethoxam chemically known as N-[3-[(2-chloro-1,3-thiazol-5-yl)methyl]-5-methyl-1,3,5-oxadiazinan-4-ylidene]nitramid and having chemical structure as below:

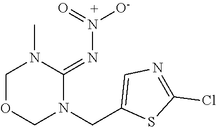

Thiamethoxam is a broad-spectrum, systemic insecticide, which means it is absorbed quickly by plants and transported to all of its parts, including pollen, where it acts to deter insect feeding. An insect can absorb it in its stomach after feeding, or through direct contact, including through its tracheal system. The compound gets in the way of information transfer between nerve cells by interfering with nicotinic acetylcholine receptors in the central nervous system, and eventually paralyzes the muscles of the insects.

As used herein, the term “Thiamethoxam” encompasses Thiamethoxam or its agrochemically acceptable salt(s), derivative(s) or any other modified form of Thiamethoxam.

Clothianidin is an insecticide belonging to neonicotinoid class of compounds. Neonicotinoids are a class of insecticides that are chemically similar to nicotine. Clothianidin is chemically known as 1-(2-Chloro-1,3-thiazol-5-ylmethyl)-3-methyl-2-nitroguanidine and having chemical structure as below:

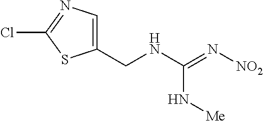 [SMILES: CN/C(=N\[N+](=O)[O-])NCc1cnc(Cl)s1]

Clothianidin and other neonicotinoids act on the central nervous system of insects as an agonist of acetylcholine, the neurotransmitter that stimulates nAChR, targeting the same receptor site (AChR) and activating post-synaptic acetylcholine receptors but not inhibiting AChE.

As used herein, the term “Clothianidin” encompasses Clothianidin or its agrochemically acceptable salt(s), derivative(s) or any other modified form of Clothianidin.

The present invention also provides a process for preparing a synergistic pesticide composition of (A) Diafenthiuron (B) Pyriproxyfen (C) at least one insecticide wherein insecticide(s) is selected from Thiamethoxam, Imidacloprid, Thiacloprid, Dinotefuran, Clothianidin, Pymetrozine. A synergistically effective amount of Diafenthiuron is an amount preferably ranging from 5% to 60% by weight of the composition and Pyriproxyfen is an amount preferably ranging from 1 to 25% by weight of the composition. The Diafenthiuron Technical grade provided in a purity of 97% minimum and Pyriproxyfen, Technical grade provided in a purity of 98% minimum. The insecticide(s) selected from Thiamethoxam, Imidacloprid, Thiacloprid, Dinotefuran, Clothianidin, Pymetrozine compounds present in an amount preferably ranging from 0.5 to 50% by weight of the composition Technical grade having a purity of 95% minimum.

In an embodiment of the invention, the present invention provides a synergistic pesticidal composition comprising A) Diafenthiuron is present in an amount in the range from 5.0 to 60% w/w; B) Pyriproxyfen is present in an amount in the range from 1.0 to 25% w/w; C) at least one more insecticide selected from Thiamethoxam, Imidacloprid, Thiacloprid, Dinotefuran, Clothianidin, Pymetrozine, is present in an amount in the range from 0.5 to 50% w/w.

In another embodiment, the present invention provides a synergistic pesticidal composition comprising:
a) Diafenthiuron in an amount in the range from 15-35% w/w, Pyriproxyfen in an amount in the range from 5-25% w/w, Thiamethoxam in an amount in the range from 2.5-15% w/w and one or more inactive excipients, or
b) Diafenthiuron in an amount in the range from 5-14% w/w, Pyriproxyfen in an amount in the range from 2.8-4% w/w, Thiamethoxam in an amount in the range from 15.1-35% w/w and one or more inactive excipients, or
c) Diafenthiuron in an amount in the range from 40-60% w/w, Pyriproxyfen in an amount in the range from 1-2.7% w/w, Thiamethoxam in an amount in the range from 35.1-50% w/w and one or more inactive excipients, or
d) Diafenthiuron in an amount in the range from 15-35% w/w, Pyriproxyfen in an amount in the range from 5-25% w/w, Imidacloprid in an amount in the range from 5-15% w/w and one or more inactive excipients, or
e) Diafenthiuron in an amount in the range from 5-14% w/w, Pyriproxyfen in an amount in the range from 2.8-4.9% w/w, Imidacloprid in an amount in the range from 15.1-35% w/w and one or more inactive excipients, or
f) Diafenthiuron in an amount in the range from 40-60% w/w, Pyriproxyfen in an amount in the range from 1-2.7% w/w, Imidacloprid in an amount in the range from 35.1-50% w/w and one or more inactive excipients, or
g) Diafenthiuron in an amount in the range from 15-35% w/w, Pyriproxyfen in an amount in the range from 5-25% w/w, Thiacloprid in an amount in the range from 2.5-10% w/w and one or more inactive excipients, or
h) Diafenthiuron in an amount in the range from 5-14% w/w, Pyriproxyfen in an amount in the range from 2.8-4.9% w/w, Thiacloprid in an amount in the range from 10-20% w/w and one or more inactive excipients, or
i) Diafenthiuron in an amount in the range from 40-60% w/w, Pyriproxyfen in an amount in the range from 1-2.7% w/w, Thiacloprid in an amount in the range from 20.1-50% w/w and one or more inactive excipients, or
j) Diafenthiuron in an amount in the range from 15.0-35.0% w/w, Pyriproxyfen in an amount in the range from 5.0-25% w/w, Dinotefuran in an amount in the range from 0.5-15% w/w and one or more inactive excipients, or
k) Diafenthiuron in an amount in the range from 5.0-14% w/w, Pyriproxyfen in an amount in the range from 2.8-4.9% w/w, Dinotefuran in an amount in the range from 15.1-35% w/w and one or more inactive excipients, or
l) Diafenthiuron in an amount in the range from 40-60% w/w, Pyriproxyfen in an amount in the range from 1.0-2.7% w/w, Dinotefuran in an amount in the range from 35.1-50% w/w and one or more inactive excipients, or
m) Diafenthiuron in an amount in the range from 15-35% w/w, Pyriproxyfen in an amount in the range from 5-25% w/w, Clothianidin in an amount in the range from 2.5-15% w/w and one or more inactive excipients, or
n) Diafenthiuron in an amount in the range from 5-14% w/w, Pyriproxyfen in an amount in the range from 2.8-4.9% w/w, Clothianidin in an amount in the range from 15.1-25% w/w and one or more inactive excipients, or
o) Diafenthiuron in an amount in the range from 40-60% w/w, Pyriproxyfen in an amount in the range from 1-2.7% w/w, Clothianidin in an amount in the range from 25.1-40% w/w and one or more inactive excipients, or
p) Diafenthiuron in an amount in the range from 15-35% w/w, Pyriproxyfen in an amount in the range from 5-25% w/w, Pymetrozine in an amount in the range from 0.5-15% w/w and one or more inactive excipients, or
q) Diafenthiuron in an amount in the range from 5-14% w/w, Pyriproxyfen in an amount in the range from 2.8-4.9% w/w, Pymetrozine in an amount in the range from 15.1-35% w/w and one or more inactive excipients, or
r) Diafenthiuron in an amount in the range from 40-60% w/w, Pyriproxyfen in an amount in the range from 1-2.7% w/w, Pymetrozine in an amount in the range from 35.1-50% w/w and one or more inactive excipients

In a preferred embodiment, the synergistic pesticidal composition comprises of:
a) Diafenthiuron in an amount in the range from 15.0-35.0% w/w, Pyriproxyfen in an amount in the range from 5.0-25% w/w, Dinotefuran in an amount in the range from 0.5-15% w/w and one or more inactive excipients, or
b) Diafenthiuron in an amount in the range from 5.0-14% w/w, Pyriproxyfen in an amount in the range from 2.8-4.9% w/w, Dinotefuran in an amount in the range from 15.1-35% w/w and one or more inactive excipients, or
c) Diafenthiuron in an amount in the range from 40-60% w/w, Pyriproxyfen in an amount in the range from 1.0-2.7% w/w, Dinotefuran in an amount in the range from 35.1-50% w/w and one or more inactive excipients

In a more preferred embodiment, the synergistic pesticidal composition is a suspoemulsion (SE), formulation comprising of:
a) Pyriproxyfen in an amount of 8% w/w by weight of the composition;
b) Dinotefuran in an amount of 5% w/w by weight of the composition;
c) Diafenthiuron in an amount of 18% w/w by weight of the composition;
d) Emulsifier selected form Blend of anionic & Non-ionic;
e) Dispersing Agent selected form Tristyrylphenol Ethoxylate & craft polymer;
f) Propylene Glycol as Anti-freezing Agent
g) Sodium lauryl sulphate as Wetting Agent;
h) Siloxane polyalkyleneoxide as Antifoaming Agent;
i) Silicon Dioxide as thickener;
j) Benzisothiazolin-3-one as Anti-bacterial;
k) Xanthan Gum.

In a more preferred embodiment, the synergistic pesticidal composition is a wettable powder (WP) formulation comprising of:
a) Pyriproxyfen in an amount of 8% w/w by weight of the composition;
b) Dinotefuran in an amount of 5% w/w by weight of the composition;
c) Diafenthiuron in an amount of 18% w/w by weight of the composition;
d) Dispersing Agent selected from Napthalene sulfonic acid branched and linear sodium salt;
e) Sodium disopropyl naphthalene sulfonate as Wetting Agent;
f) Siloxane polyalkyleneoxide as Antifoaming Agent;
g) Fillers.

In a more preferred embodiment, the synergistic pesticidal composition is a Water Dispersible Granules (WDG) formulation comprising of:
a) Pyriproxyfen in an amount of 8% w/w by weight of the composition;
b) Dinotefuran in an amount of 5% w/w by weight of the composition;
c) Diafenthiuron in an amount of 18% w/w by weight of the composition;
d) Dispersing Agent is selected from Methyl Napthalene sulfonic acid polymer with formaldehyde sodium salt;
e) Sodium lauryl sulphate as Wetting Agent;
f) Siloxane polyalkyleneoxide as Antifoaming Agent;
g) Citric acid/Sod. Bicarbonate as Disintegration Agent;
h) Fillers.

The composition according to the invention can be applied to any and all developmental stages of pests, in particular sucking pests, such as egg, nymph, larva, pupa, and adult. The pests may be controlled by contacting the target pest, its food supply, habitat, breeding ground or its locus with a pesticidally effective amount of the inventive composition.

The inventors of the present invention have surprisingly found that the composition of the present invention is synergetic in nature. The synergetic composition of the present invention is more effective than their individual counterparts or when two actives are taken together. The synergetic composition of the present invention also makes it possible to use markedly smaller quantities of the active ingredients as compared to their individual counterparts. This allows a substantial reduction in the application rates of each of these active ingredients, while maintaining good efficacy. The decrease in application rates reduces treatment cost to the farmer and also eases the burden on the environment both from manufacturing waste and crop protection chemical residues.

The synergistic pesticidal composition of present invention provides a wide spectrum control of insect-pests, delays the emergence of the resistant strains, minimizing the risk of development of resistance, and achieves effective and economical control of undesired insect-pest.

The synergistic composition of the present invention provides a number of other advantages:
Increased efficacy in comparison to the other formulations tested during the trial.
Economically beneficial to the farmers as it provides better yield of the crop with reduction in the number of sprays.
Reduced possibility of hazards to the farmers due to occupational exposure because of reduction in the number of sprays.
Is storage stable.
Is non-phytotoxic.
Environmental friendly

The novel active ingredient composition has very advantageous curative, preventive and systemic pesticidal properties for protecting cultivated plants. As has been mentioned, said active ingredient composition can be used to inhibit or destroy the pathogens that occur on plants or parts of plants (fruit, blossoms, leaves, stems, tubers, roots) of different crops or useful plants, while at the same time those parts of plants which grow later are also protected from attack by such pathogens. Active ingredient composition has the special advantage of being highly active against diseases in the soil that mostly occur in the early stages of plant development.

The compositions of Diafenthiuron; Pyriproxyfen and at least agrochemically active ingredients selected from Thiamethoxam, Imidacloprid, Thiacloprid, Dinotefuran, Clothianidin, and Pymetrozine are also suitable for controlling against many phytophagous insects pests likes; Aphid, Jassid, Thrips, Mealybugs, Scales, Leaf miner, Gall midges, shootfly, stemfly, stemborer, root borer, fruitborer. It controls insects pests from the following orders: Lepidoptera, for example Agrotis ipsilon, Anticarsia gemmatalis, Chilo partellus, Cnaphalocrosis medinalis, Cydia pomonella, Diaphania nitidalis, Earias insulana, Elasmopalpus lignosellus, Heliothis armigera, Heliothis virescens, Heliothis zea, Hellula undalis, Hyphantria cunea, Hyponomeuta malinellus, Leucoptera coffeella, Leucoptera scitella, Ostrinia nubilalis, Panolis flammea, Pectinophora gossypiella, Peridroma saucia, Phalera bucephala, Phthorimaea operculella, Phyllocnistis citrella, Pieris bras-sicae, Plutella xylostella, Sitotroga cerealella, Sesamia inferans, Sparganothis pilleriana, Spodoptera frugiperda, Spodoptera littoralis, Spodoptera litura, Thaumatopoea pityocampa, Tortrix viridana, Trichoplusia ni, beetles (Coleoptera), for example Agrilus sinuatus, Agriotes lineatus, Agriotes obscu-rus, Amphimallus solstitialis, Anisandrus dispar, Anthonomus grandis, Anthonomus pomorum, Aphthona euphoridae, Apogonia aerea, Athous haemorrhoidalis, Atomaria linearis, Blasto-phagus piniperda, Blitophaga undata, Brahmina coriacea, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus napi, Chaetocnema tibialis, Conoderus vespertinus, Crioceris asparagi, Ctenicera ssp., Diabrotica longicornis, Diabrotica semipunctata, Diabrotica 12-punctata Diabrotica speciosa, Diabrotica virgifera, Epila-chna varivestis, Epitrix hirtipennis, Eutinobothrus brasiliensis, White grub species, Holotrichia consanguinea, Holotrichia serrata, Holotrichia longipennis, Hylobius abietis, Hypera brunneipennis, Hypera postica, Ips typographus, Lema bilineata, Lema melanopus, Lepidiota stigma, Leptinotarsa decemlineata, Limonius califomicus, Lissorhoptrus oryzophilus, Melanotus communis, Meligethes aeneus, Melolontha hippocastani, Melolontha melolontha, Oberea (Obereopsis) brevis, Oulema oryzae, Ortiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sito-philus gran aria, flies, (Diptera), e.g. Atherigona orientalis, Atherigona soccata, Athalia lugen proxima, Dacus cucurbi-tae, Dacus oleae, Glossina palpalis, Haematobia irritans, Haplodiplosis equestris, Hippelates spp., Hylemyia platura, Hypoderma lineata, Leptoconops torrens, Leaf miner, Liriomyza sativae, Liriomyza trifolii, Lucilia caprina, Lucilia cuprina, Lucilia sericata, Lycoria pectoralis, Mansonia titillanus, Mayetiola destructor, Oscinella frit, Phorbia brassicae, Prosimulium mixtum, Rhagoletis cerasi, Sarcophaga sp., Simulium vittatum, Stomoxys calcitrans, Tabanus bovinus, Tabanus atratus, Tabanus lineola, and Tabanus similis, Tipula oleracea, and Tipula paludosa, thrips (Thysanoptera), e.g. Dichromothrips corbetti, Dichromothrips ssp, Frankliniella fusca, Frankliniella occidentalis, Frankliniella tritici, Scirtothrips citri, Scirtothrips dorsalis, Thrips oryzae, Thrips palmi and Thrips tabaci, termites (Isoptera), e.g. Calotermes flavicollis, Coptotermes formosanus, Heterotermes aureus, Leucotermes flavipes, Microtermes spp., Odontotermes, Reticulitermes flavipes, Reticulitermes virginicus, Reticulitermes lucifugus and Termes natalensis; true bugs (Hemiptera), e.g. Acrosternum hilare, Amrasca biguttula biguttula, Amrasca devastans, Blissus leucopterus, Dysdercus cingulatus, Eurygaster integriceps, Euschistus impictiventris, Leptoglossus phyllopus, Lygus lineolaris, Lygus pratensis, Nezara viridu-la, Piesma quadrata, Solubea insularis, Thyanta perditor, Acyrthosiphon onobrychis, Adelges laricis, Aphidula nasturtii, Aphis fabae, Aphis forbesi, Aphis pomi, Aphis gossypii, Aphis crassivora, Aphis grossulariae, Aphis schneideri, Aphis spiraecola, Aphis sambuci, Acyrtho-siphon pisum, Aulacorthum solani, Bemisia argentifolii, Bemisia tabaci, Brachycaudus cardui, Brachy-caudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Ma-crosiphon rosae, Megoura viciae, Melanaphis pyrarius, Metopolophium dirhodum, My-zus persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mail, Psylla piri, Rhopalomyzus ascalonicus, Rhopalosiphum maidis, Rhopalosi-phum padi, Rhopalosiphum insertum, Sappaphis mala, Sappaphis mail, Schizaphis graminum, Schizoneura lanuginosa, Sitobion avenae, Trialeurodes vaporariorum, Toxoptera aurantiia d, Viteus vitifolii, Cimex lectularius, Cimex hemipterus, Reduvius senilis, Triatoma spp., and Arilus critatus, Trialeurodes vaporariorum, Amrasca biguttula, Empoasca spp., Myzus spp., Nephotettix spp., Nilaparvata spp., Planococcus spp., Pseudococcus spp., Psylla spp., Rhopalosiphum spp., Sitobion spp., Amritodus atkinsoni, Idioscopus spp., ants, bees, wasps, sawflies (Hymenoptera), e.g. Athalia rosae, Atta cephalotes, Atta capiguara, Atta cephalotes, Atta laevigata, Atta robusta, Atta sexdens, Atta texana, Crematogaster spp., Hoplocampa minuta, Hoplocampa testudinea, Monomorium pha-raonis, Solenopsis geminata, Solenopsis invicta, Solenopsis richteri, Solenopsis xyloni, Pogonomyrmex barbatus, Pogonomyrmex californicus, Pheidole megacephala, Dasy-mutilla occidentalis, Bombus spp. Vespula squamosa, Paravespula vulgaris, Paraves-pula pennsylvanica, Paravespula germanica, Dolichovespula maculata, Vespa crabro, Polistes rubiginosa, Camponotus floridanus, and Linepithema humile, crickets, grasshoppers, locusts (Orthoptera), e.g. Acheta domestica, Gryllotalpa gryllo-talpa, Locusta migratoria, Melanoplus bivittatus, Melanoplus femurrubrum, Melanoplus mexicanus, Melanoplus sanguinipes, Melanoplus spretus, Nomadacris septemfasciata, Schistocerca americana, Schistocerca gregaria, Dociostaurus maroccanus, Tachycines asynamorus, Oedaleus senegalensis, Zonozerus variegatus, Hieroglyphus daganensis, Kraussaria angulifera, Calliptamus italicus, Chortoicetes terminifera, and Locustana pardalina, plant parasitic nematodes such as root-knot nematodes, Meloidogyne arenaria, Meloidogyne incognita, Meloidogyne javanica; cyst nematodes, Globodera rostochiensis, Heterodera avenae; seed gall nematodes, Anguina funesta, Anguina tritici and other Anguina species; stem and foliar nematodes, Aphelenchoides besseyi, sting nematodes, Belonolaimus longicaudatus and other plant parasitic nematode species.

Suitable targets for seed treatment are various crop seeds, fruit species, vegetables, spices and ornamental seed, for example corn/maize (sweet and field), durum wheat, soybean, Groundnut, wheat, barley, oats, rye, triticale, bananas, rice, cotton, sunflower, potatoes, pasture, alfalfa, grasses, turf, sorghum, rapeseed, Brassica spp., sugar beet, egg-plants, tomato, lettuce, iceberg lettuce, pepper, cucumber, squash, melon, bean, dry-beans, peas, leek, garlic, onion, cabbage, carrot, tuber such as sugar cane, tobacco, coffee, turf and forage, cruciferous, cucurbits, grapevines, pepper, fodder beet, oil seed rape, pansy, impatiens, petunia and geranium.

The composition of the present invention is effective for management of insect or pests in of Cotton (Gossypium spp.), Paddy (Oryza sativa), Wheat (Triticumaestavum), Barley (Hordeumvulgare), Maize (Zea mays), Sorghum (Sorghum bicolor), Sugarcane (Saccharumofficinarum), Sugarbeet (Beta vulgaris), Soybean (Glycin max), Peanut (Arachishypogaea), Sunflower (Helianthus annuus), Mustard (Brassica juncea), Rape seed (Brassica napus), Linseed (Linumusitatissimum), Sesame (Sesamumindicum), Castor (Ricinuscommunis), Green gram (Vigna radiate), Black gram (Vignamungo), Chickpea (Ciceraritinum), Cowpea (Vignaunguiculata), Redgram (Cajanuscajan), Frenchbean (Phaseolus vulgaris), Indian bean (Lablab purpureus), Horse gram (Macrotylomauniflorum), Field pea (Pisumsativum), Cluster bean (Cyamopsistetragonoloba), Lentils (Lens culinaris), Brinjal (Solanum melongena), Cabbage (Brassica oleracea var. capitata), Cauliflower (Brassica oleracea var. botrytis), Okra (Abelmoschus esculentus), Onion (Allium cepa L.), Tomato (Solanumlycopersicun), Potato (Solanumtuberosum), Sweet potato (Ipomoea batatas), Chilly (Capsicum annum), Garlic (Allium sativum), Cucumber (Cucumissativus), Muskmelons (Cucumismelo), Watermelon (Citrulluslanatus), Bottle gourd (Lagenariasiceraria), Bitter gourd (Momordicacharantia), Radish (Raphanussativus), Carrot (Dacuscarota sub sp. sativus), Turnip (Brassica rapasubsprapa), Apple (Melusdomestica), Banana (Musa spp.), Citrus groups (Citrus spp.), Grape (Vitisvinifera), Guava (Psidiumguajava), Litchi (Litchi chinensis), Mango (Mangiferaindica), Papaya (Carica papaya), Pineapple (Ananascomosus), Pomegranate (Punicagranatum), Sapota (Manilkarazapota), Tea (Camellia sinensis), Coffea (Coffea Arabica), Turmeric (Curcuma longa), Ginger (Zingiberofficinale), Cumin (Cuminumcyminum), Fenugreek (Trigonellafoenum-graecum), Fennel (Foeniculumvulgare), Coriander (Coriandrumsativum), Ajwain (Trachyspermumammi), Psyllium (Plantago ovate), Black Pepper (Piper nigrum), Stevia (Stevia rebaudiana), Safedmusli (Chlorophytumtuberosum), Drum stick (Moringaoleifera), Coconut (Coco nucifera), Mentha (Mentha spp.), Rose (Rosa spp.), Jasmine (Jasminum spp.), Marigold (Tagetes spp.), Common daisy (Bellisperennis), Dahlia (Dahlia hortnesis), Gerbera (Gerbera jamesonii), Carnation (Dianthus caryophyllus) or GMO form thereof.

The composition of the present invention can be used to control the insects-pests belongs to Lepidopteran insects, Chilopartellus, Chilosuppressalis, Cydiapomonella, Plutellaxylostella, Peirisrapae, beetles (coleopteran), e.g. Dicladispaarmigera, Phyllotretanemorum, Phyllotretastriolata, flies (Diptera), e.g. Atherigonaorientalis, Dacuscucurbi-tae, Dacusoleae, Liriomyzasativae, Liriomyzatrifolii, Melanagromyza obtuse, Ophiomyiaphaseli, thrips (Thysanoptera), e.g. Frankliniellaoccidentalis, Scirtothripscitri, Scirtothrips dorsalis, Thrips oryzae, Thrips palmi and Thrips tabaci, true bugs (Hemiptera), e.g. Amrascabiguttulabiguttula, Amrascadevastans, Amritodusatkinsoni, Aphis fabae, Aphis pomi, Aphis gossypii, Aphis crassivora, Bemisiaargentifolii, Bemisiatabaci, Brevicorynebrassicae, Clavigrallagibbosa, Dysdercuscingulatus, Idioscopus spp., Leptocorisaacuta, Lyguslineolaris, Myzuspersicae, Nilaparvatalugens, Nephotettixvirescens, Nephotettixnigropictus, Planococcus spp., Pseudococcus spp., Pyrillaperpusilla, Psylla mail, Psyllapiri, Rhopalomyzusascalonicus, Rhopalosiphummaidis, Rhopalosi-phumpadi, Rhopalosiphuminsertum, Sappaphis mala, Sappaphis mail, Schizaphisgraminum, Schizoneuralanuginosa, Sitobionavenae, Sogatellafurcifera, Trialeurodesvaporariorum, Toxopteraaurantiia, Psylla spp., Rhopalosiphum spp., Sitobion spp., crickets, grasshoppers, locusts (Orthoptera), e.g. Gryllotalpagryllo-talpa, Locustamigratoria, Melanoplusbivittatus, Locustanapardalina, from the order Acarina, for example, Brevipalpus spp., Eriophyes spp., Olygonychuscoffeae, Panonychus spp., Polyphagotarsonemuslatus, Tarsonemus spp. and Tetranychus spp. (Tetranychusurticae, Tetranychuscinnabarinus, Tetranychustelarius).

The term seed treatment comprises all suitable seed treatment techniques known in the art, such as, but not limited to, seed dressing, seed coating, seed dusting, seed soaking, seed film coating, seed multilayer coating, seed encrusting, seed dripping, and seed pelleting.

The active ingredient composition according to the invention are especially advantageous for seed treatment of oil seed rape, wheat, corn, rye, barley, oats, sorghum, sunflowers, rice, maize, turf and forage, sugar beet, beans, peas, soybeans, ornamentals, and vegetables such as cucurbits, tomatoes, eggplant, potatoes, pepper, lettuce, cabbage, carrots, cruciferous.

The term “health of a plant” or “plant health” is defined as a condition of the plant and/or its products. As a result of the improved health, yield, plant vigor, quality and tolerance to abiotic or biotic stress are increased. Noteworthy, the health of a plant when applying the method according to the invention, is increased independently of the pesticidal properties of the active ingredients used because the increase in health is not based upon the reduced pest pressure but instead on complex physiological and metabolic reactions which result for example in an activation of the plant's own natural defense system. As a result, the health of a plant is increased even in the absence of pest pressure. Accordingly, in an especially preferred embodiment of the method according to the invention, the health of a plant is increased both in the presence and absence of biotic or abiotic stress factors. The above identified indicators for the health condition of a plant may be interdependent or they may result from each other. An increase in plant vigor may for example result in an increased yield and/or tolerance to abiotic or biotic stress. One indicator for the condition of the plant is the yield. “Yield” is to be understood as any plant product of economic value that is produced by the plant such as grains, fruits in the proper sense, vegetables, nuts, grains, seeds, wood (e.g. in the case of silviculture plants) or even flowers (e.g. in the case of gardening plants, ornamentals). The plant products may in addition be further utilized and/or processed after harvesting.

In an especially preferred embodiment of the invention, the yield of the treated plant is increased.

In another preferred embodiment of the invention, the yield of the plants treated according to the method of the invention, is increased synergistically.

According to the present invention, “increased yield” of a plant, in particular of an agricultural, silvicultural and/or horticultural plant means that the yield of a product of the respective plant is increased by a measurable amount over the yield of the same product of the plant produced under the same conditions, but without the application of the mixture according to the invention.

Increased yield can be characterized, among others, by the following improved proper-ties of the plant: increased plant, weight, increased plant height, increased biomass such as higher overall fresh weight (FW), increased number of flowers per plant, higher grain yield, more tillers or side shoots (branches), larger leaves, increased shoot growth, increased protein content, increased oil content, increased starch content, increased pigment content, increased leaf are index. According to the present invention, the yield is increased by at least 4%, preferable by 5 to 10%, more preferable by 10 to 20%, or even 20 to 30% compared to the untreated control plants or plants treated with pesticides in a way different from the method according to the present invention. In general, the yield increase may even be higher.

A further indicator for the condition of the plant is the plant vigor. The plant vigor becomes manifest in several aspects such as the general visual appearance. In another especially preferred embodiment of the invention, the plant vigor of the treated plant is increased. In another preferred embodiment of the invention, the plant vigor of the plants treated according to the method of the invention is increased synergistically. Improved plant vigor can be characterized, among others, by the following improved properties of the plant: improved vitality of the plant, improved plant growth, improved plant development, improved visual appearance, improved plant stand (less plant verse/lodging), improved emergence, enhanced root growth and/or more developed root system, enhanced nodulation, in particular rhizobial nodulation, bigger leaf blade, bigger size, increased plant weight, increased plant height, increased tiller number, increased number of side shoots, increased number of flowers per plant, increased shoot growth, increased root growth (extensive root system), increased yield when grown on poor soils or unfavorable climate, enhanced photosynthetic activity (e.g. based on increased stomatal conductance and/or increased C02 assimilation rate), increased stomatal conductance, increased C02 assimilation rate, enhanced pigment content (e.g. chlorophyll content), earlier flowering, earlier fruiting, earlier and improved germination, earlier grain maturity, improved self-defense mechanisms, improved stress tolerance and resistance of the plants against biotic and abiotic stress factors such as fungi, bacteria, viruses, insects, heat stress, cold stress, drought stress, UV stress and/or salt stress, less non-productive tillers, less dead basal leaves, less input needed (such as fertilizers or water), greener leaves, complete maturation under shortened vegetation periods, less fertilizers needed, less seeds needed, easier harvesting, faster and more uniform ripening, longer shelf-life, longer panicles, delay of senescence, stronger and/or more productive tillers, better extractability of ingredients, improved quality of seeds (for being seeded in the following seasons for seed production), better nitrogen uptake, improved reproduction, reduced production of ethylene and/or the inhibition of its reception by the plant.

The improvement of the plant vigor according to the present invention particularly means that the improvement of any one or several or all of the above mentioned plant characteristics are improved independently of the pesticidal action of the mixture or active ingredients (components).

Another indicator for the condition of the plant is the “quality” of a plant and/or its products.

In an especially preferred embodiment of the invention, the quality of the treated plant is increased.

In another preferred embodiment of the invention, the quality of the plants treated according to the method of the invention, is increased synergistically.

According to the present invention, enhanced quality means that certain plant characteristics such as the content or composition of certain ingredients are increased or improved by a measurable or noticeable amount over the same factor of the plant produced under the same conditions, but without the application of the mixtures of the present invention. Enhanced quality can be characterized, among others, by following improved properties of the plant or its product: increased nutrient content, increased protein content, increased content of fatty acids, increased metabolite content, increased carotenoid content, increased sugar content, increased amount of essential amino acids, improved nutrient composition, improved protein composition, improved composition of fatty acids, improved metabolite composition, improved carotenoid composition, improved sugar composition, improved amino acids composition, improved or optimal fruit color, improved leaf color, higher storage capacity, higher processability of the harvested products.

Another indicator for the condition of the plant is the plant's tolerance or resistance to biotic and/or abiotic stress factors. Biotic and abiotic stress, especially over longer terms, can have harmful effects on plants. Biotic stress is caused by living organisms while abiotic stress is caused for example by environmental extremes. According to the present invention, “enhanced tolerance or resistance to biotic and/or abiotic stress factors” means (1.) that certain negative factors caused by biotic and/or abiotic stress are diminished in a measurable or noticeable amount as compared to plants exposed to the same conditions, but without being treated with a mixture according to the invention and (2.) that the negative effects are not diminished by a direct action of the mixture according to the invention on the stress factors, e.g. by its fungicidal or 10 insecticidal action which directly destroys the microorganisms or pests, but rather by a stimulation of the plants' own defensive reactions against said stress factors.

Formulation of the present invention can be in any of the formulations selected from Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable Slurry (FS), Flowable Suspension (FS), Suspension Concentrate (SC), Suspension concentrate for direct application (SD), Suspo-emulsion (SE), Water soluble granule (SG), Soluble concentrate (SL), Water soluble powder (SP), Water dispersible powder for slurry seed treatment (WS), Water dispersible granules (WDG), Wettable powders (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW) comprising (A) Diafenthiuron (B) Pyriproxyfen (C) at least one insecticide selected from Thiamethoxam, Imidacloprid, Thiacloprid, Dinotefuran, Clothianidin, and Pymetrozine and one or more inactive excipients such as a) dispersant b) wetting agent c) anti-foaming agent d) biocides/anti-bacterial e) anti-freezing agent f) suspending agent g)thickener h) coating agent and i) buffering agent and binders.

One or more of the active ingredients is encapsulated for various purposes, such as to increase the residual biological activity, or to reduce the acute toxicity, or to obtain a physical or chemically stable water-based formulation. The purpose determines whether the “free” active ingredient and the “release rate” are relevant properties of a specific product.

Diafenthiuron; Pyriproxyfen; and at least one insecticides selected from Thiamethoxam, Imidacloprid, Thiacloprid, Dinotefuran, Clothianidin, Pymetrozine; which are bio active ingredient for the present composition are present in specific fixed ratio.

The composition of the present invention in addition to bioactive amounts of Diafenthiuron; Pyriproxyfen; and one more agrochemically active ingredients selected from Thiamethoxam, Imidacloprid, Thiacloprid, Dinotefuran, Clothianidin, Pymetrozine; further comprises inactive excipients including but not limited to dispersant, anti-freezing agent, anti-foam agent, wetting agent, suspension aid, antimicrobial agent, thickener, quick coating agent or sticking agents (also referred to as “stickers” or “binders”) and buffering agent.

An agriculturally acceptable carrier may be solid, liquid or both. Solid carries are essentially: mineral earth such as silicas, silica gels, silicates, talc, kaolin, montmorillonite, attapulgite, pumice, sepiolite, bentonite, limestone, lime, chalk, bole, loes, clay, dolomite, diatomaceous earth, calcite, calcium sulfate, magnesium sulfate, magnesium sulfate, magnesium oxide, sand, ground plastics, ferilizers such as ammonium sulfate, ammonium phosphate, ammonium nitrate, ureas, and crushed products of vegetable origin such as cereal meal, tree bark meal, wood meal and nutshell meal, cellulose powders, or other solid carriers.

The synergistic composition of Diafenthiuron; Pyriproxyfen; and at least one agrochemically active ingredients selected from Thiamethoxam, Imidacloprid, Thiacloprid, Dinotefuran, Clothianidin, Pymetrozine may optionally include surfactant(s) which are non-ionic, cationic and/or anionic in nature and surfactant mixtures which have good emulsifying, dispersing and wetting properties, depending on the nature of the active ingredient to be formulated. Suitable anionic surfactants can be both so-called water-soluble soaps and water-soluble synthetic surface-active compounds. Soaps which may be included as a surfactant are the alkali metal, alkaline earth metal or substituted or unsubstituted ammonium salts of higher fatty acids (C₁₀-C₂₂), for example the sodium or potassium salt of oleic or stearic acid, or of natural fatty acid mixtures.

A dispersant is a substance which adsorbs onto the surface of particles and helps to preserve the state of dispersion of the particles and prevents them from re-aggregating. Dispersants are added to agrochemical formulations to facilitate dispersion and suspension during manufacture, and to ensure the particles re-disperse into water in a spray tank. They are widely used in wettable powders, suspension concentrates and water-dispersible granules. Surfactants that are used as dispersants have the ability to adsorb strongly onto a particle surface and provide a charged or steric barrier to reaggregation of particles. The most commonly used surfactants are anionic, non-ionic, or mixtures of the two types. For wettable powder formulations, the most common dispersants are sodium lingo sulphonates. For suspension concentrates, very good adsorption and stabilization are obtained using polyelectrolytes, such as sodium naphthalene sulphonate formaldehyde condensates. Tristyryl phenol ethoxylate phosphate esters are also used. Nonionics such as alkyl aryl ethylene oxide condensates and EO-PO block copolymers are sometimes combined with anionics as dispersants for suspension concentrates. In recent years, new types of very high molecular weight polymeric surfactants have been developed as dispersants. These have very long hydrophobic ‘backbones’ and a large number of ethylene oxide chains forming the ‘teeth’ of a ‘comb’ surfactant. These high molecular weight polymers can give very good long-term stability to suspension concentrates because the hydrophobic backbones have many anchoring points onto the particle surfaces. Examples of dispersants used herein include but not limited to sodium lingo sulphonates; sodium naphthalene sulphonate formaldehyde condensates; tristyryl phenol ethoxylate phosphate esters; aliphatic alcohol ethoxylates; alky ethoxylates; EO-PO block copolymers; and graft copolymers or mixtures thereof.

Anti-freezing agent as used herein can be selected from the group consisting of polyethylene glycols, methoxy polyethylene glycols, polypropylene glycols, polybutylene glycols, glycerine and ethylene glycol. Water-based formulations often cause foam during mixing operations in production. In order to reduce the tendency to foam, anti-foam agents are often added either during the production stage or before filling into bottles. Generally, there are two types of antifoam agents, namely silicones and non-silicones. Silicones are usually aqueous emulsions of dimethyl poly siloxane while the non-silicone anti-foam agents are water-insoluble oils, such as octanol and nonanol, or silica. In both cases, the function of the anti-foam agent is to displace the surfactant from the air-water interface.

A wetting agent is a substance that when added to a liquid increases the spreading or penetration power of the liquid by reducing the interfacial tension between the liquid and the surface on which it is spreading. Wetting agents are used for two main functions in agrochemical formulations: during processing and manufacture to increase the rate of wetting of powders in water to make concentrates for soluble liquids or suspension concentrates; and during mixing of a product with water in a spray tank or other vessel to reduce the wetting time of wettable powders and to improve the penetration of water into water-dispersible granules. Examples of wetting agents used in wettable powder, suspension concentrate, and water-dispersible granule formulations include but not limited to sodium lauryl sulphate; sodium dioctyl sulpho succinate; alkyl phenol ethoxylates; and aliphatic alcohol ethoxylates or mixtures thereof.

Suspension aid in the present description denotes a natural or synthetic, organic or inorganic material with which the active substance is combined in order to facilitate its application to the plant, to the seeds or to the soil. This carrier is hence generally inert, and it must be agriculturally acceptable, in particular to the plant being treated. The carrier may be solid (clays, natural or synthetic silicates, silica, resins, waxes, solid fertilizers, and the like or mixtures thereof) or liquid (water, alcohols, ketones, petroleum fractions, aromatic or paraffinic hydrocarbons, chlorinated hydrocarbons, liquefied gases, and the like or mixtures thereof).

An emulsifier is a kind of surfactant. It helps to prevent the droplets of the dispersed phase of an emulsion from flocculating or coalescing in the emulsion. It can be or include a cationic, zwitterionic or a non-ionic emulsifier.

Biocides/Ant-bacterials: Microorganisms cause spoilage of formulated products. Therefore antimicrobial agents are used to eliminate or reduce their effect. Examples of such agents include, but are not limited to: propionic acid and its sodium salt; sorbic acid and its sodium or potassium salts; benzoic acid and its sodium salt; p-hydroxy benzoic acid sodium salt; methyl p-hydroxy benzoate; and biocide such as sodium benzoate, 1,2-benzisothiazoline-3-one, 2-methyl-4-isothiazolin-3-one, 5-chloro-2-methyl-4-isothiazolin-3-one, potassium sorbate, para hydroxy benzoates or mixtures thereof.

Thickeners or gelling agents are used mainly in the formulation of suspension concentrates, emulsions and suspoemulsions to modify the rheology or flow properties of the liquid and to prevent separation and settling of the dispersed particles or droplets. Thickening, gelling, and anti-settling agents generally fall into two categories, namely water-insoluble particulates and water-soluble polymers. It is possible to produce suspension concentrate formulations using clays and silicas. Examples of these types of materials, include, but are limited to, montmorillonite, e.g. bentonite; magnesium aluminum silicate; and attapulgite. Water-soluble polysaccharides have been used as thickening-gelling agents for many years. The types of polysaccharides most commonly used are natural extracts of seeds and seaweeds are synthetic derivatives of cellulose or mixtures thereof. Examples of these types of materials include, but are not limited to, guar gum; locust bean gum; carrageenam; xanthan gum; alginates; methyl cellulose; sodium carboxymethyl cellulose (SCMC); hydroxyethyl cellulose (HEC) or mixtures thereof. Other types of anti-settling agents are based on modified starches, polyacrylates, polyvinyl alcohol and polyethylene oxide or mixtures.

The quick coating agent can be a conventionally available sticker, for example polyesters, polyamides, poly-carbonates, polyurea and polyurethanes, acrylate polymers and copolymers, styrene copolymers, butadiene copolymers, polysaccharides such as starch and cellulose derivatives, vinyl alcohol, vinyl acetate and vinyl pyrrolidone polymers and copolymers, polyethers, epoxy, phenolic and melamine resins, polyolefins and define copolymers and mixtures thereof. Examples of preferred polymers are acrylate polymers such as poly(methacrylate), poly(ethyl methacrylate), poly(methyl methacrylate), acrylate copoylmers and styrene-acrylic copolymers as defined herein below, poly(styrene-co maleic anhydride), cellulosic polymers such as ethyl cellulose, cellulose acetate, cellulose acetatebutyrate, acetylated mono, di, and triglycerides, poly(vinyl pyrrolidone), vinyl acetate polymers and copolymers, poly(alkylene glycol), styrene butadiene copolymers, poly(ortho esters), alkyd resins, and mixtures of two or more of these.

Polymers that are biodegradable are also useful in the present invention. As used herein, a polymer is biodegradable if is not water soluble, but is degraded over a period of several weeks when placed in an application environment. Examples of biodegradable polymers that are useful in the present invention include biodegradable polyesters, starch, polylactic acid starch blends, polylactic acid, poly(lactic acid-glycolic acid) copolymers, polydioxanone, cellulose esters, ethyl cellulose, cellulose acetate butyrate, starch esters, starch ester aliphatic polyester blends, modified corn starch, poly capro lactone, poly(namylmethacrylate), wood rosin, poly anhydrides, poly vinyl alcohol, poly hydroxyl butyrate valerate, biodegradable aliphatic polyesters, and poly hydroxyl butyrate or mixtures thereof.

A defoamer, also called as anti-foaming agent, is generally added to the composition as foam formation prevents the efficient filling of a container. Suitable defoamer used herein, but not limited to, Siloxane polyalkylene oxide.

Buffering agent as used herein is selected from group consisting of calcium hydroxyapatite, Potassium Dihydrogen Phosphate, Sodium Hydroxide, carbonated apatite, calcium carbonate, sodium bicarbonate, tricalcium phosphate, calcium phosphates, carbonated calcium phosphates, amine monomers, lactate dehydrogenase and magnesium hydroxide.

The solvent for the formulation of the present invention may include water, water soluble alcohols and dihydroxy alcohol ethers. The water-soluble alcohol which can be used in the present invention may be lower alcohols or water-soluble macromolecular alcohols. The term “lower alcohol”, as used herein, represents an alcohol having 1-4 carbon atoms, such as methanol, ethanol, n-propanol, isopropanol, n-butanol, tertbutanol, etc. Macromolecular alcohol is not limited, as long as it may be dissolved in water in a suitable amount range, e.g., polyethylene glycol, sorbitol, glucitol, etc. The examples of suitable dihydroxy alcohol ethers used in the present invention may be dihydroxy alcohol alkyl ethers or dihydroxy alcohol aryl ethers. The examples of dihydroxy alcohol alkyl ether include ethylene glycol methyl ether, diethylene glycol methyl ether, propylene glycol methyl ether, dipropylene glycol methyl ether, ethylene glycol ethyl ether, diethylene glycol ethyl ether, propylene glycol ethyl ether, dipropylene glycol ethyl ether, etc. The examples of dihydroxy alcohol aryl ethers include ethylene glycol phenyl ether, diethylene glycol phenyl ether, propylene glycol phenyl ether, dipropylene glycol phenyl ether, and the like. Any of the above mentioned solvent can be used either alone or in combination thereof.

The composition according to the present invention may further comprises of additional components such as a surfactant, an agriculturally acceptable support, carrier or filler, protective colloids, adhesives, thixotropic agents, penetration agents, stabilisers, or sequestering agents.

In an embodiment, the present invention provides a process for preparing the present novel synergistic composition which may be modified accordingly by any person skilled in the art based on the knowledge of the manufacturing the formulation. However, all such variations and modifications are still covered by the scope of present invention.

| Sr. | | |
|---|---|---|
| No. | Raw Materials Details | % w/w |
| 01 | Pyriproxyfen Technical (97% basis) | 08.25 |
| 02 | Dinotefuran Technical (98% basis) | 05.11 |
| 03 | Diafenthiuron Technical (97.5% basis) | 18.47 |
| 04 | Surfactant/Emulsifier - Blend of anionic & | 10.50 |
| | Non-ionic | |
| 05 | Dispersing Agent- Ethoxylated Tristryl phenol | 01.10 |
| | Sulphate | |
| 06 | Dispersing Agent- Tristyrylphenol Ethoxylate | 01.50 |
| 07 | Co-dispersing Agent-Acrylic polymer amine salt | 00.50 |
| 08 | Anti-freezing Agent -Mono Ethylene Glycol | 02.50 |
| 09 | Wetting Agent- Tristyrylphenol ethoxylate nonionic | 02.50 |
| | emulsifier | |
| 10 | Antifoaming Agent-Siloxane polyalkyleneoxide | 00.10 |
| 11 | Thickener- Silicon Dioxide | 00.40 |
| 12 | Thickener- Clay | 00.40 |
| 13 | Anti-bacterial - Benzisothiazolin-3-one | 00.10 |
| 14 | Binder-Xanthan Gum | 00.17 |
| 15 | Demineralised(DM)Water | Q.S. to |
| | | make 100% |
| | Total | 100.00 |

These and other advantages of the invention may become more apparent from the examples set forth herein below. These examples are provided merely as illustrations of the invention and are not intended to be construed as a limitation thereof.

### Example-1

### Preparation of a Synergistic Pesticidal Composition Comprising Pyriproxyfen 8%+Dinotefuran 5%+Diafenthiuron 18% SC

### Chemical Composition: 100% Basis

| Sr. | | |
|---|---|---|
| No. | Raw Materials Details | % w/w |
| 01 | Pyriproxyfen Technical (98% basis) | 08.20 |
| 02 | Dinotefuran Technical (99% basis) | 05.05 |
| 03 | Diafenthiuron Technical (97% basis) | 18.56 |
| 04 | Surfactant/Emulsifier - Blend of anionic & | 10.50 |
| | Non-ionic | |
| 05 | Dispersing Agent- Ethoxylated Tristryl phenol | 01.10 |
| | Sulphate | |
| 06 | Dispersing Agent- Tristyrylphenol Ethoxylate | 01.50 |
| 07 | Co-dispersing Agent-Acrylic polymer amine salt | 00.50 |
| 08 | Anti-freezing Agent -Mono Ethylene Glycol | 02.50 |
| 09 | Wetting Agent- Tristyrylphenol ethoxylate nonionic | 02.50 |
| | emulsifier | |
| 10 | Antifoaming Agent-Siloxane polyalkyleneoxide | 00.10 |
| 11 | Thickener- Silicon Dioxide | 00.40 |
| 12 | Thickener- Clay | 00.40 |
| 13 | Anti-bacterial - Benzisothiazolin-3-one | 00.10 |
| 14 | Xanthan Gum | 00.17 |
| 15 | DM Water | Q.S. to |
| | | make 100% |
| | Total | 100.00 |

### Example-2

### Preparation of a Synergistic Pesticidal Composition Comprising Pyriproxyfen+Dinotefuran+Diafenthiuron SC

Chemical Composition: with Range of RM

| Sr. | | |
|---|---|---|
| No. | Raw Materials Details | % w/w |
| 01 | Pyriproxyfen Technical | 01.0-25.00 |
| 02 | Dinotefuran Technical | 00.50-50.00 |
| 03 | Diafenthiuron Technical | 01.00-85.00 |
| 04 | Surfactant/Emulsifier - Blend of anionic & | 01.00-10.00 |
| | Non-ionic/Catanionic | |
| 05 | Dispersing Agent- Tristyrylphenol Ethoxylate | 00.50-10.00 |
| | Amine salt of phosphate tristyryl phenol | |
| | ethylated/Acrylic Copolymer/Ethoxylated | |
| | Tristryl phenol Sulphate | |
| 06 | Anti-freezing Agent -Mono Ethylene | 01.00-10.00 |
| | Glycol/Propylene glycol/Diethylene glycol | |
| 07 | Wetting Agent- Tristyrylphenol ethoxylate nonionic | 01.00-10.00 |
| | emulsifier/Mixture of non-ionic surfactants | |
| | & Alkoxileted Alcohol | |
| 08 | Antifoaming Agent-Siloxane polyalkyleneoxide | 00.01-1.00 |
| 09 | Thickener- Silicon Dioxide/China - | 00.50-5.00 |
| | Clay/Kaolin/Talc/starch | |
| 10 | Anti-bacterial - Benzisothiazolin-3-one/ | 00.01-1.00 |
| | Formaldehyde | |
| 11 | Xanthan Gum | 00.01-1.00 |
| 12 | DM Water | Q.S. to |
| | | make 100% |
| | Total | 100.00 |

### Manufacturing Method:

Take required quantity of Pyriproxyfen technical and melt it at 48° C. and add emulsifier blend of anionic & Non-ionic mix homogeneous, then add Ethoxylated Tristryl phenol Sulphate, Tristyrylphenol Ethoxylate and Acrylic polymer amine salt and mix homogeneous.

Take 75% of DM water of recipe in premix vessel and add require quantity of Dinotefuran technical under stirring, material should be in suspension form then add mono ethylene glycol, china clay, ppt silica and Tristyrylphenol ethoxylate nonionic emulsifier mix homogeneous and added Diafenthiuron technical, antifoam and premix of Pyriproxyfen solution, mix homogeneous suspension.

The above mixed mass is grinding in Bead Mill. Grinding is carried out until a mean particle size of 3-5(D-90) microns is obtained.

After the grinding, add 2% water solution of xanthan gum under low stirring. After homogeneous mixed, check for quality parameter.

### Example-3

### Preparation of a Synergistic Pesticidal Composition Comprising Pyriproxyfen 8%+Dinotefuran 5%+Diafenthiuron 18% SE

| Sr. | | |
|---|---|---|
| No. | Raw Materials Details | % w/w |
| 01 | Pyriproxyfen Technical (98% basis) | 08.20 |
| 02 | Dinotefuran Technical (99% basis) | 05.05 |
| 03 | Diafenthiuron Technical (97% basis) | 18.56 |
| 04 | Emulsifier - Blend of anionic & | 05.00 |
| | Non-ionic | |
| 05 | Dispersing Agent- Tristyrylphenol Ethoxylate | 03.00 |
| | & craft polymer | |
| 06 | Anti-freezing Agent - Propylene Glycol | 05.00 |
| 07 | Wetting Agent- Sodium lauryl sulphate | 02.00 |
| 08 | Antifoaming Agent-Siloxane polyalkyleneoxide | 00.10 |
| 09 | Thickener- Silicon Dioxide | 00.40 |
| 10 | Anti-bacterial - Benzisothiazolin-3-one | 00.10 |
| 11 | Xanthan Gum | 00.20 |
| 12 | DM Water | Q.S. to |
| | | make 100% |
| | Total | 100.00 |

Process for preparation of above said composition wherein the dispersing cum wetting agent/surfactant, emulsifier is first diluted in D. M. Water, and solubilized by high shear mixing then add anti freezing agent, Dinotefuran technical, deformer and mix to make homogeneous then add Pyriproxyfen, Diafenthiuron technical and mix to make homogeneous mass.

The above mixed mass is grinded in Bead Mill. Grinding is carried out until a mean particle size of 3-5(D-90) microns is obtained. After the grinding, add 2% water solution of xanthan gum under low stirring.

### Example-4

### Preparation of a Synergistic Pesticidal Composition Comprising Pyriproxyfen 8%+Dinotefuran 5%+Diafenthiuron 18% WP

| Sr. | | |
|---|---|---|
| No. | Raw Materials Details | % w/w |
| 01 | Pyriproxyfen Technical (98% basis) | 08.20 |
| 02 | Dinotefuran Technical (99% basis) | 05.05 |
| 03 | Diafenthiuron Technical (97% basis) | 18.56 |
| 04 | Dispersing Agent- Napthalene sulfonic | 10.00 |
| | acid branched and linear sodium salt | |
| 05 | Wetting Agent- Sodium disopropyl naphthalene | 03.00 |
| | sulfonate | |
| 06 | Antifoaming Agent-Siloxane polyalkyleneoxide | 00.05 |
| 07 | Fillers (Silica/clay) | Q.S. to |
| | | make 100% |
| | Total | 100.00 |

Process for preparation of above said composition: weigh all the ingredients as per table and mix well using proper ribbon blender type mixer.

Thereafter, mill this premixing with suitable air jet mill/Air classifier mill. Keep the milling chamber 6 kg per cm2-8 kg per cm2 and feeding pressure 2 kg per cm2. Mill the material to achieving desired particle size.

Withdraw milled material in ribbon blender type mixer for post mixing. Mix well proper homogeneous.

### Example-5

### Preparation of a Synergistic Pesticidal Comprising Pyriproxyfen 8%+Dinotefuran 5%+Diafenthiuron 18% WDG

| Sr. | | |
|---|---|---|
| No. | Raw Materials Details | % w/w |
| 01 | Pyriproxyfen Technical (98% basis) | 08.20 |
| 02 | Dinotefuran Technical (99% basis) | 05.05 |
| 03 | Diafenthiuron Technical (97% basis) | 18.56 |
| 04 | Dispersing Agent- Methyl Napthalene sulfonic acid | 12.00 |
| | polymer with formaldehyde sodium salt | |
| 05 | Wetting Agent- Sodium lauryl sulphate | 05.00 |
| 06 | Antifoaming Agent-Siloxane polyalkyleneoxide | 00.10 |
| 07 | Disintegration Agent - Citric acid/Sod. bicarbonate | 02.00 |
| 08 | Fillers (Silica/clay) | Q.S. to |
| | | make 100% |
| | Total | 100.00 |

Process for preparation: The above said composition is produced by mixing all the raw materials such as wetting agent, dispersing agent, Fillers and technical's in the given proportion.

The above mass mix in blender properly and grinding by jet mill/ACM. Grinding is carried out until a desired particle size is obtained. After grinding mix homogeneous by blender then prepared dough by dough mixer and carried out granules by extruder. After making granules, granules dry by hot air (FBD) or oven.

### Example-6

### Evaluation of Synergistic Effect of the Pesticidal Composition of the Present Invention:

Evaluation of the synergistic insecticidal effect of the composition comprising Diafenthiuron, Pyriproxyfen and an insecticide Dinotefuran can be established by using any synergistic insecticidal composition prepared by the process described in the above examples. For these evaluations one or more of the synergistic insecticidal compositions prepared in the examples are used here.

| | Dose | Active compound - | | | | | | | | Dose |
|---|---|---|---|---|---|---|---|---|---|---|
| Active | Rate | Dinotefuran | | | | | | | Active | Rate |
| Compound | (ppm) | Dose Rate (ppm) | | | | | | | Compound | (ppm) |
| Diafenthiuron | 0 | 0 | 15 | 30 | 45 | 60 | 75 | 90 | Pyriproxyfen | 0 |
| | 60 | 0 | 15 | 30 | 45 | 60 | 75 | 90 | | 24 |
| | 120 | 0 | 15 | 30 | 45 | 60 | 75 | 90 | | 48 |
| | 180 | 0 | 15 | 30 | 45 | 60 | 75 | 90 | | 72 |
| | 240 | 0 | 15 | 30 | 45 | 60 | 75 | 90 | | 96 |
| | 360 | 0 | 15 | 30 | 45 | 60 | 75 | 90 | | 120 |
| | 480 | 0 | 15 | 30 | 45 | 60 | 75 | 90 | | 144 |

Treatments of White fly which are used are shown in Table 2.

Synergistic insecticidal effect of a combination of Dinotefuran
+ Diafenthiuron + Pyriproxyfen

| | | | | Observed | Expected | |
|---|---|---|---|---|---|---|
| | | | | Mortality | Mortality | |
| Sr. No. | Dinotefuran | Diafenthiuron | Pyriproxyfen | % | % | Difference |
| 1 | 45 | 0 | 0 | 35.10 | — | |
| 2 | 60 | 0 | 0 | 45.50 | | |
| 3 | 75 | 0 | 0 | 52.00 | — | |
| 4 | 90 | 0 | 0 | 61.40 | — | |
| 5 | 0 | 120 | 0 | 38.40 | | |
| 6 | 0 | 240 | 0 | 48.50 | — | |
| 7 | 0 | 360 | 0 | 57.30 | — | |
| 8 | 0 | 480 | 0 | 61.80 | — | |
| 9 | 0 | 0 | 72 | 30.70 | | |
| 10 | 0 | 0 | 96 | 38.10 | — | |
| 11 | 0 | 0 | 120 | 43.70 | — | |
| 12 | 0 | 0 | 144 | 46.60 | — | |
| 13 | 45 | 120 | 72 | 60.00 | 72.29 | −12.29 |
| 14 | 45 | 240 | 96 | 83.10 | 79.31 | 3.79 |
| 15 | 45 | 360 | 120 | 87.10 | 84.40 | 2.70 |
| 16 | 45 | 480 | 144 | 90.90 | 86.76 | 4.14 |
| 17 | 60 | 120 | 72 | 67.30 | 76.73 | −9.43 |
| 18 | 60 | 240 | 96 | 94.10 | 82.63 | 11.47 |
| 19 | 60 | 360 | 120 | 94.30 | 86.90 | 7.40 |
| 20 | 60 | 480 | 144 | 95.10 | 88.88 | 6.22 |
| 21 | 75 | 120 | 72 | 69.90 | 79.51 | −9.61 |
| 22 | 75 | 240 | 96 | 94.00 | 84.70 | 9.30 |
| 23 | 75 | 360 | 120 | 95.80 | 88.46 | 7.34 |
| 24 | 75 | 480 | 144 | 96.70 | 90.21 | 6.49 |
| 25 | 90 | 120 | 72 | 69.00 | 83.52 | −14.52 |
| 26 | 90 | 240 | 96 | 96.50 | 87.69 | 8.81 |
| 27 | 90 | 360 | 120 | 97.10 | 90.72 | 6.38 |
| 28 | 90 | 480 | 144 | 98.40 | 92.13 | 6.27 |

Treatments of Jassids which are used are shown in Table 3.

Synergistic insecticidal effect of a combination of Dinotefuran
+ Diafenthiuron + Pyriproxyfen

| | | | | Observed | Expected | |
|---|---|---|---|---|---|---|
| | | | | Mortality | Mortality | |
| Sr. No. | Dinotefuran | Diafenthiuron | Pyriproxyfen | % | % | Difference |
| 1 | 45 | 0 | 0 | 65.60 | — | |
| 2 | 60 | 0 | 0 | 73.40 | | |
| 3 | 75 | 0 | 0 | 79.00 | — | |
| 4 | 90 | 0 | 0 | 83.80 | — | |
| 5 | 0 | 120 | 0 | 28.90 | | |
| 6 | 0 | 240 | 0 | 42.00 | — | |
| 7 | 0 | 360 | 0 | 48.50 | — | |
| 8 | 0 | 480 | 0 | 57.40 | — | |
| 9 | 0 | 0 | 72 | 21.70 | | |
| 10 | 0 | 0 | 96 | 29.20 | — | |
| 11 | 0 | 0 | 120 | 35.50 | — | |
| 12 | 0 | 0 | 144 | 37.90 | — | |
| 13 | 45 | 120 | 72 | 77.70 | 80.85 | −3.15 |
| 14 | 45 | 240 | 96 | 81.60 | 85.87 | −4.27 |
| 15 | 45 | 360 | 120 | 85.50 | 88.57 | −3.07 |
| 16 | 45 | 480 | 144 | 90.90 | 90.90 | 0.00 |
| 17 | 60 | 120 | 72 | 85.50 | 85.19 | 0.31 |
| 18 | 60 | 240 | 96 | 93.90 | 89.08 | 4.82 |
| 19 | 60 | 360 | 120 | 95.00 | 91.16 | 3.84 |
| 20 | 60 | 480 | 144 | 96.60 | 92.96 | 3.64 |
| 21 | 75 | 120 | 72 | 90.40 | 88.31 | 2.09 |
| 22 | 75 | 240 | 96 | 95.00 | 91.38 | 3.62 |
| 23 | 75 | 360 | 120 | 95.00 | 93.02 | 1.98 |
| 24 | 75 | 480 | 144 | 96.70 | 94.44 | 2.26 |
| 25 | 90 | 120 | 72 | 94.40 | 90.98 | 3.42 |
| 26 | 90 | 240 | 96 | 97.50 | 93.35 | 4.15 |
| 27 | 90 | 360 | 120 | 98.20 | 94.62 | 3.58 |
| 28 | 90 | 480 | 144 | 98.40 | 95.71 | 2.69 |

### Example-7

Synergism can be calculated by using the Colby's method i.e. the expected (or predicted) response of the combination is calculated by taking the product of the observed response for each individual component of the combination when applied alone divided by 100 and subtracting this value from the sum of observed response for each component when applied alone. Synergism of the combination is then determined by comparing the observed response of the combination to the expected (or predicted) response as calculated from the observed response of each individual component alone. If the observed response of the combination is greater than the expected (or predicted) response then the combination is said to be synergistic and falls within the definition of synergistic effect. (Colby, S. R., Weeds, 1967(15), p. 20-22).

TABLE 4
Synergistic insecticidal effect of a combination of Diafenthiuron 18% + Dinotefuran5% + Pyriproxyfen
8% -SC spray application Observed Expected No. Mortality (%) White fly on days after spray. Mortality
(%) White fly on days after -Diafenthiuron 18% + Dinotefuran5% + Pyriproxyfen 8% -SC spray application

| | | | | | Mortality | | Mortality | | Mortality | Mean |
|---|---|---|---|---|---|---|---|---|---|---|
| | | | | | 7DAT | | 7DAT | | 7DAT | mortality |
| | Active | | Formulation | | after | | after | | after | due |
| | Ingredient | | Quantity | | 1st | | 2nd | | 3rd | to 3 |
| S. No. | g a.i./ha dose | | (g/ha) | Pre-count | Spray | Pre-count | Spray | Pre-count | Spray | sprays |
| 1 | Diafenthiuron | 99 | 300 | 45.0 | 65.5 | 23.3 | 63.5 | 18.4 | 66.6 | 65.2 |
| | 18% + | | | | | | | | | |
| | Dinotefuran | | | | | | | | | |
| | 5% + | | | | | | | | | |
| | Pyriproxyfen | | | | | | | | | |
| | 8% -SC | | | | | | | | | |
| 2 | Diafenthiuron | 198 | 600 | 33.3 | 86.5 | 11.2 | 88.8 | 13.5 | 90.7 | 88.7 |
| | 18% + | | | | | | | | | |
| | Dinotefuran | | | | | | | | | |
| | 5% + | | | | | | | | | |
| | Pyriproxyfen | | | | | | | | | |
| | 8% -SC | | | | | | | | | |
| 3 | Diafenthiuron | 396 | 1200 | 42.3 | 89.0 | 10.1 | 88.5 | 12.1 | 92.3 | 89.9 |
| | 18% + | | | | | | | | | |
| | Dinotefuran | | | | | | | | | |
| | 5% + | | | | | | | | | |
| | Pyriproxyfen | | | | | | | | | |
| | 8% -SC | | | | | | | | | |
| 4 | Dinotefuran | 30 | 150 | 36.3 | 62.0 | 25.6 | 67.7 | 24.3 | 72.0 | 67.2 |
| | 20% SG | | | | | | | | | |
| 5 | Pyriproxyfen | 50 | 500 | 51.0 | 64.5 | 30.0 | 60.3 | 26.6 | 65.7 | 63.5 |
| | 10% EC | | | | | | | | | |
| 6 | Diafenthiuron | 239 | 500 | 45.5 | 69.0 | 18.8 | 71.1 | 16.8 | 74.3 | 71.5 |
| | 47.8% SC | | | | | | | | | |
| 7 | Untreated | — | — | 48.6 | −24.0 | 56.6 | −30.2 | 51.7 | −28.5 | −27.6 |
| | control | | | | | | | | | |
| | (water | | | | | | | | | |
| | spray) | | | | | | | | | |

As can be seen from the data shown in Table 4, combinations of Diafenthiuron+Dinotefuran+Pyriproxyfen demonstrate synergistic insect control of White fly.

TABLE 5
Synergistic insecticidal effect of a combination of Diafenthiuron 18% + Dinotefuran5% + Pyriproxyfen
8% -SC spray application Observed Expected No. Mortality (%) Jassids on days after spray. Mortality
(%) Jassids on days after -Diafenthiuron 18% + Dinotefuran5% + Pyriproxyfen 8% -SC spray application

| | | | | | Mortality | | Mortality | | Mortality | Mean |
|---|---|---|---|---|---|---|---|---|---|---|
| | | | | Pre-count | 7DAT | Pre-count | 7DAT | Pre-count | 7DAT | mortality |
| | Active | | Formulation | before | after | before | after | before | after | due |
| Sr. | Ingredient | | Quantity | 1st | 1st | 2nd | 2nd | 3rd | 3rd | to 3 |
| No. | g a.i./ha dose | | (g/ha) | Spray | Spray | spray | Spray | Spray | Spray | sprays |
| 1 | Diafenthiuron | 99 | 300 | 12.2 | 63.4 | 14.5 | 63.5 | 9.6 | 72.1 | 66.3 |
| | 18% + | | | | | | | | | |
| | Dinotefuran5% + | | | | | | | | | |
| | Pyriproxyfen | | | | | | | | | |
| | 8% -SC | | | | | | | | | |
| 2 | Diafenthiuron | 198 | 600 | 9.3 | 86.5 | 8.5 | 93.4 | 5.5 | 95.5 | 91.8 |
| | 18% + | | | | | | | | | |
| | Dinotefuran5% + | | | | | | | | | |
| | Pyriproxyfen | | | | | | | | | |
| | 8% -SC | | | | | | | | | |
| 3 | Diafenthiuron | 396 | 1200 | 15.0 | 90.7 | 9.1 | 94.1 | 5.1 | 93.9 | 92.9 |
| | 18% + | | | | | | | | | |
| | Dinotefuran5% + | | | | | | | | | |
| | Pyriproxyfen | | | | | | | | | |
| | 8% -SC | | | | | | | | | |
| 4 | Dinotefuran | 30 | 150 | 18.1 | 88.7 | 7.6 | 87.9 | 6.1 | 90.3 | 89.0 |
| | 20% SG | | | | | | | | | |
| 5 | Pyriproxyfen | 50 | 500 | 16.5 | 45.5 | 13.2 | 40.4 | 11.1 | 48.4 | 44.8 |
| | 10% EC | | | | | | | | | |
| 6 | Diafenthiuron | 239 | 500 | 8.7 | 56.7 | 10.1 | 63.2 | 8.3 | 68.9 | 62.9 |
| | 47.8% SC | | | | | | | | | |
| 7 | Untreated | — | — | 10.2 | −17.7 | 18.9 | −28.9 | 15.9 | −23.9 | −23.5 |
| | control (water | | | | | | | | | |
| | spray) | | | | | | | | | |

As can be seen from the data shown in Table 5, combinations of Diafenthiuron+Dinotefuran+Pyriproxyfen demonstrate synergistic insect control of Jassids.

From Table-4 and 5, Diafenthiuron 18%+Dinotefuran 5%+Pyriproxyfen 8%−SC at concentrations of 600, 1200, g/ha are effective and superior at first and second sprays respectively which are superior and or on par with standard checks tested against as compared Dinotefuran 20% SG 300 g/ha, Pyriproxyfen 10% EC 300 g/ha and Diafenthiuron 47.8% SC 300 g/ha and untreated is as effective as standard checks after the first spray.

### Example 8

### Bio-Efficacy of the Pesticidal Composition of the Present Invention:

The following provides the evaluation of the synergistic insecticidal effect of a combination of Diafenthiuron+Dinotefuran+Pyriproxyfen against White fly and Jassids on cotton.

In this example most of the synergistic insecticidal compositions prepared by the process described in this invention are used to evaluate their activities.

In this evaluation, percent mortality of hoppers is worked out based on the number of White fly and Jassids counted before and after sprays and based on dead heart counts before and after sprays. The data is averaged and analyzed for the test of significance.

### Details of the Experiment:

a. Design: Randomised block design
b. Replication: Three
c. Product: Diafenthiuron 18%+Dinotefuran 5%+Pyriproxyfen 8%
d. Treatment: Seven (as shown in details in the Table-6)

TABLE 6
Details of the treatments of combination of
Dinotefuran + Diafenthiuron + Pyriproxyfen
Details of the treatments done

| S. | | | Formulation Quantity |
|---|---|---|---|
| No. | Active Ingredient g a.i./ha dose | | (g/ha) |
| 1 | Diafenthiuron 18% + | 99 | 300 |
| | Dinotefuran5% + | | |
| | Pyriproxyfen 8% -SC | | |
| 2 | Diafenthiuron 18% + | 198 | 600 |
| | Dinotefuran5% + | | |
| | Pyriproxyfen 8% -SC | | |
| 3 | Diafenthiuron 18% + | 396 | 1200 |
| | Dinotefuran5% + | | |
| | Pyriproxyfen 8% -SC | | |
| 4 | Dinotefuran 20% SG | 99 | 300 |
| 5 | Pyriproxyfen 10% EC | 99 | 300 |
| 6 | Diafenthiuron 47.8% SC | 99 | 300 |
| 7 | Untreated control | — | — |

In this evaluation, White fly and Jassids are studied for effect of Pesticidal Composition of Pyriproxyfen, Dinotefuran and Diafenthiuron. On the Cotton crop, 1st Spray was done at the emergence of the pest at ETL level. 2nd Spray was done 15 days after the First Spray and 3rd Spray 15 days after the Second Spray.

| | |
|---|---|
| Plot Size | 5 × 4 m = 20 Sq. m. |
| Cotton Variety | RCH-773 |
| Spacing | 90 × 60 cm |
| Fertilizer | N:P:K 50:25:25 kg/ha |
| Sprayer used | Knapsack sprayer |
| Spray volume | 1.25 litre per 20 sq. m. plot |

Method: Required quantity of spray fluid is prepared before spray application and for phytotoxicity studies concentration of Dinotefuran+Diafenthiuron+Pyriproxyfen at 300, 600, 1200 g/ha is laid out separately by the side of the bio-efficacy trial plot to avoid drift of the chemical.

| | | |
|---|---|---|
| 1st Spray | — | At the emergence of the pest at ETL level |
| 2nd Spray | — | 15 days after the First Spray |
| 3rd Spray | — | 15 days after the Second Spray |

Observations recorded: i. Pre and post treatment data of green leaf hopper in three leaves from the base, middle and top position of the plants, brown plant hoppers on the stem portions.
Phytotoxicity of higher concentrations.
yield.

Method of Observation: Phytotoxicity in terms of yellowing, Stunting, Chlorosis, Leaf tip injury, Wilting, Hyponasty/Epinasty for all treatments of leaves is recorded. When the crop attained maturity the 1st., 2nd picking, subsequent the final picking. The total yield was computed to Mt/ha. The data is analyzed statistically to discriminate the treatment superiority for control leaf eating pests and variation in the yield.

TABLE 7
Observation

| | |
|---|---|
| 1 | Bio- efficacy: On 0 Day (pre count), 7th and |
| | 14th Day after each spray test count for |
| | whitefly and Jassids (Adults + nymphs) |
| 2 | Phytotoxicity: Recorded plant phtotoxicity |
| | after sprays based on 0-10 scale of assessment |
| | of yellowing, Stunting, Chlorosis, Leaf tip |
| | injury, Wilting, Hyponasty/Epinasty for all treatments |
| 3 | Yield: 1st., 2nd picking, subsequent the final picking. |
| | The total yield was converted in Mt/ha |

TABLE 8
Cotton seed lint yield kg/ha

| Cotton seed lint yield kg/ha | | | | Seed |
|---|---|---|---|---|
| Sr. | | | Formulation | cotton |
| No. | Active Ingredient g a.i./ha dose | | Quantity (g/ha) | kg/ha |
| 1 | Diafenthiuron 18% + | 99 | 300 | 1798 |
| | Dinotefuran5% + | | | |
| | Pyriproxyfen 8% -SC | | | |
| 2 | Diafenthiuron 18% + | 198 | 600 | 2334 |
| | Dinotefuran 5% + | | | |
| | Pyriproxyfen 8% -SC | | | |
| 3 | Diafenthiuron 18% + | 396 | 1200 | 2386 |
| | Dinotefuran5% + | | | |
| | Pyriproxyfen 8% -SC | | | |
| 4 | Dinotefuran 20% SG | 99 | 300 | 1866 |
| 5 | Pyriproxyfen 10% EC | 99 | 300 | 1806 |
| 6 | Diafenthiuron 47.8% SC | 99 | 300 | 1976 |
| 7 | Untreated control | — | — | 1455 |

TABLE 9
Phytotoxicity

| | | | | Mean of |
|---|---|---|---|---|
| | | | | Cumulative |
| | Phytotoxicity due to application of pesticides | | | Phytotoxicity |
| Sr. | | | Formulation | (%) on 14th |
| No. | Active Ingredient g a.i./ha dose | | Quantity (g/ha) | Day |
| 1 | Diafenthiuron 18% + | 99 | 300 | NP |
| | Dinotefuran5% + | | | |
| | Pyriproxyfen 8% -SC | | | |
| 2 | Diafenthiuron 18% + | 198 | 600 | NP |
| | Dinotefuran5% + | | | |
| | Pyriproxyfen 8% -SC | | | |
| 3 | Diafenthiuron 18% + | 396 | 1200 | *3.00% |
| | Dinotefuran5% + | | | |
| | Pyriproxyfen 8% -SC | | | |
| 4 | Dinotefuran 20% SG | 99 | 300 | NP |
| 5 | Pyriproxyfen 10% EC | 99 | 300 | NP |
| 6 | Diafenthiuron 47.8% | 99 | 300 | NP |
| | SC | | | |
| 7 | Untreated control | — | — | NP |

NP: No Phytotoxicity
*Phytotoxicity is negligible (3%) at the highest concentration of pre- mixture, slight reddening of leaves at early stage of crop only which were required completely after some time.

Results: The results of the field trial carried out to evaluate the bio-efficacy of and standardization of doses of Diafenthiuron 18%+Dinotefuran 5%+Pyriproxyfen 8% at doses 300, 600, 1200, g/ha as compared to Dinotefuran 20% SG 300 g/ha, Pyriproxyfen 10% EC 300 g/ha and Diafenthiuron 47.8% SC 300 g/ha and untreated check are presented in the above tables.

Diafenthiuron 18%+Dinotefuran 5%+Pyriproxyfen 8% at 300, 600, 1200, g/ha are effective against White fly and Jassids. Irrespective of concentrations yields are superior over standard checks. Phytotoxicity is negligible (2 and 3%) at the highest concentrations of 1200 g/ha.

From the foregoing it will be observed that numerous modifications and variations can be effectuated without departing from the true spirit and scope of the novel concepts of the present invention. It is to be understood that no limitations with respect to the specific embodiments illustrated is intended or should be inferred. It should be understood that all such modifications and improvements have been deleted herein for the sake of conciseness and readability but are properly within the scope of the following claims.

1. A synergistic pesticidal composition comprising:
(a) Diafenthiuron;
(b) Pyriproxyfen;
(c) at least one insecticide selected from Thiamethoxam, Imidacloprid, Thiacloprid, Dinotefuran, Clothianidin, Pymetrozine;
(d) one or more inactive excipients selected from the group comprising surfactant, dispersing agent, anti-freezing agent, wetting agent, anti-foaming agent, suspension aid, anti-microbial/bacterial agent, thickener, quick coating agent or sticking agents, buffering agent, binder and filler.

2. The synergistic pesticidal composition as claimed in claim 1, wherein
A) Diafenthiuron is present in an amount in the range from 5.0 to 60% w/w;
B) Pyriproxyfen is present in an amount in the range from 1.0 to 25% w/w;
C) at least one more insecticide selected from Thiamethoxam, Imidacloprid, Thiacloprid, Dinotefuran, Clothianidin, Pymetrozine, is present in an amount in the range from 0.5 to 50% w/w.

3. The synergistic pesticidal composition as claimed in claim 1, wherein the combinations of the active ingredients in the said pesticidal composition comprises of:
a) Diafenthiuron in an amount in the range from 15-35% w/w, Pyriproxyfen in an amount in the range from 5-25% w/w, Thiamethoxam in an amount in the range from 2.5-15% w/w and one or more inactive excipients, or
b) Diafenthiuron in an amount in the range from 5-14% w/w, Pyriproxyfen in an amount in the range from 2.8-4% w/w, Thiamethoxam in an amount in the range from 15.1-35% w/w and one or more inactive excipients, or
c) Diafenthiuron in an amount in the range from 40-60% w/w, Pyriproxyfen m an amount in the range from 1-2.7% w/w, Thiamethoxam in an amount in the range from 35.1-50 w/w and one or more inactive excipients, or
d) Diafenthiuron in an amount in the range from 15-35% w/w, Pyriproxyfen in an amount in the range from 5-25% w/w, Imidacloprid in an amount in the range from 5-15% w/w and one or more inactive excipients, or
e) Diafenthiuron in an amount in the range from 5-14% w/w, Pyriproxyfen in an amount in the range from 2.8-4.9% w/w, Imidacloprid in an amount in the range from 15.1-35% w/w and one or more inactive excipients, or
f) Diafenthiuron in an amount in the range from 40-60% w/w, Pyriproxyfen in an amount in the range from 1-2.7% w/w, Imidacloprid in an amount in the range from 35.1-50% w/w and one or more inactive excipients, or
g) Diafenthiuron in an amount in the range from 15-35% w/w, Pyriproxyfen in an amount in the range from 5-25% w/w, Thiacloprid in an amount in the range from 2.5-10% w/w and one or more inactive excipients, or
h) Diafenthiuron in an amount in the range from 5-14% w/w, Pyriproxyfen in an amount in the range from 2.8-4.9% w/w, Thiacloprid in an amount in the range from 10-20% w/w and one or more inactive excipients, or
i) Diafenthiuron in an amount in the range from 40-60% w/w, Pyriproxyfen in an amount in the range from 1-2.7% w/w, Thiacloprid in an amount in the range from 20.1-50% w/w and one or more inactive excipients, or
e) Diafenthiuron in an amount in the range from 15.0-35.0% w/w,
Pyriproxyfen in an amount in the range from 5.0-25% w/w, Dinotefuran in an amount in the range from 0.5-15% w/w and one or more inactive excipients, or
f) Diafenthiuron in an amount in the range from 5.0-14% w/w, Pyriproxyfen in an amount in the range from 2.8-4.9% w/w, Dinotefuran in an amount in the range from 15.1-35% w/w and one or more inactive excipients, or
l) Diafenthiuron in an amount in the range from 40-60% w/w, Pyriproxyfen in an amount in the range from 1.0-2.7% w/w, Dinotefuran in an amount in the range from 35.1-50% w/w and one or more inactive excipients, or
m) Diafenthiuron in an amount in the range from 15-35% w/w, Pyriproxyfen in an amount in the range from 5-25% w/w, Clothianidin in an amount in the range from 2.5-15% w/w and one or more inactive excipients, or
n) Diafenthiuron in an amount in the range from 5-14% w/w, Pyriproxyfen in an amount in the range from 2.8-4.9% w/w, Clothianidin in an amount in the range from 15.1-25% w/w and one or more inactive excipients, or
o) Diafenthiuron in an amount in the range from 40-60% w/w, Pyriproxyfen in an amount in the range from 1-2.7% w/w, Clothianidin in an amount in the range from 25.1-40% w/w and one or more inactive excipients, or
p) Diafenthiuron in an amount in the range from 15-35% w/w, Pyriproxyfen in an amount in the range from 5-25% w/w, Pymetrozine in an amount in the range from 0.5-15% w/w and one or more inactive excipients, or
q) Diafenthiuron in an amount in the range from 5-14% w/w, Pyriproxyfen in an amount in the range from 2.8-4.9% w/w, Pymetrozine in an amount in the range from 15.1-35% w/w and one or more inactive excipients, or
r) Diafenthiuron in an amount in the range from 40-60% w/w, Pyriproxyfen in an amount in the range from 1-2.7% w/w, Pymetrozine in an amount in the range from 35.1-50% w/w and one or more inactive excipients.

4. The synergistic pesticidal composition as claimed in claims 1-3, wherein the surfactant is selected from the group comprising non-ionic surfactants, cationic surfactants and anionic surfactants or blend of anionic & nonionic/Catanionic or a combination thereof and present in an amount in the range from 1.00 to 10.00% w/w.

5. The synergistic pesticidal composition as claimed in claims 1-3, wherein the dispersing agent is selected from the group comprising Tristyrylphenol Ethoxylate Amine salt of phosphate tristyryl phenol ethylated/Acrylic Copolymer/Ethoxylated Tristryl phenol Sulphate or a combination thereof and present in an amount in the range from 0.5 to 10.00% w/w.

6. The synergistic pesticidal composition as claimed in claims 1-3, wherein the anti-freezing agent is selected from the group comprising Mono Ethylene Glycol/Propylene glycol/Diethylene glycol or a combination thereof and present in an amount in the range from 0.1 to 10.00% w/w.

7. The synergistic pesticidal composition as claimed in claims 1-3, wherein the wetting agent is selected from the group comprising Tristyrylphenol ethoxylate nonionic emulsifier/Mixture of nonionic surfactants & Alkoxylated Alcohol or a combination thereof and present in an amount in the range from 0.1 to 10.00% w/w.

8. The synergistic pesticidal composition as claimed in claims 1-3, wherein the anti-foaming agent is selected from the group comprising Siloxane polyalkyleneoxide and is present in an amount in the range from 0.01 to 1.00% w/w.

9. The synergistic pesticidal composition as claimed in claims 1-3, wherein the thickener is selected from the group comprising Silicon Dioxide/China-Clay/Kaolin/Talc/starch or a combination thereof and present in an amount in the range from 0.50 to 5.00% w/w.

10. The synergistic pesticidal composition as claimed in claims 1-3, wherein the binder is selected as Xanthum Gum and is present in an amount in the range from 0.01 to 1.00% w/w.

11. The synergistic pesticidal composition as claimed in claims 1-3, wherein the composition is formulated as selected from Emulsifiable concentrate (EC), Emulsifiable granule (EG), Emulsion water-in-oil (EO), Emulsifiable powder (EP), Emulsion for seed treatment (ES), Emulsion oil-in-water (EW), Flowable Slurry (FS), Flowable Suspension (FS), Suspension Concentrate (SC), Suspension concentrate for direct application (SD), Suspo-emulsion (SE), Water soluble granule (SG), Soluble concentrate (SL), Water soluble powder (SP), Water dispersible powder for slurry seed treatment (WS), Water dispersible granules (WDG), Wettable powders (WP), Water dispersible powder for slurry seed treatment (WS), Water dispersible tablet (WT), a mixed formulation of CS and SC (ZC) or A mixed formulation of CS and SE (ZE), a mixed formulation of CS and EW (ZW).

12. The synergistic pesticidal composition as claimed in claims 1-11, wherein the suspoemulsion (SE), formulation comprises of:
a) Pyriproxyfen in an amount of 8% w/w by weight of the composition;
b) Dinotefuran in an amount of 5% w/w by weight of the composition;
c) Diafenthiuron in an amount of 18% w/w by weight of the composition;
d) Surfactant/Emulsifier selected form Blend of anionic & Non-ionic;
e) Dispersing Agent selected form Tristyrylphenol Ethoxylate & craft polymer;
f) Propylene Glycol as Anti-freezing Agent
g) Sodium lauryl sulphate as Wetting Agent;
h) Siloxane polyalkyleneoxide as Antifoaming Agent;
i) Silicon Dioxide as thickener;
j) Benzisothiazolin-3-one as Anti-bacterial;
k) Xanthan Gum as binder.

13. The synergistic pesticidal composition as claimed in claims 1-11, wherein the wettable powder (WP) formulation comprises of:
a) Pyriproxyfen in an amount of 8% w/w by weight of the composition;
b) Dinotefuran in an amount of 5% w/w by weight of the composition;
c) Diafenthiuron in an amount of 18% w/w by weight of the composition;
d) Dispersing Agent selected from Napthalene sulfonic acid branched and linear sodium salt;
e) Sodium disopropyl naphthalene sulfonate as Wetting Agent;
f) Siloxane polyalkyleneoxide as Antifoaming Agent;
g) Fillers.

14. The synergistic pesticidal composition as claimed in claims 1-11, wherein the Water Dispersible Granules (WDG) formulation comprises of:
h) Pyriproxyfen in an amount of 8% w/w by weight of the composition;
i) Dinotefuran in an amount of 5% w/w by weight of the composition;
j) Diafenthiuron in an amount of 18% w/w by weight of the composition;
k) Dispersing Agent is selected from Methyl Napthalene sulfonic acid polymer with formaldehyde sodium salt;
l) Sodium lauryl sulphate as Wetting Agent;
m) Siloxane polyalkyleneoxide as Antifoaming Agent;
n) Citric acid/Sod. Bicarbonate as Disintegration Agent;
o) Fillers.
